(19) United States
(12) Patent Application Publication
(10) Pub. No.: US 2018/0060495 A1
(43) Pub. Date: Mar. 1, 2018

(54) METHOD AND SYSTEM FOR DATA PROCESSING TO RECOMMEND MEDICAL INTERVENTION ACTIVITIES FOR CAREGIVERS AND/OR HUMAN SUBJECTS

(71) Applicant: Conduent Business Services, LLC, Dallas, TX (US)

(72) Inventors: Jyotirmaya Mahapatra, Jajpur (IN); Kundan Shrivastava, Bangalore (IN); Nimmi Rangaswamy, Medak (IN); Saurabh Srivastava, Bangalore (IN)

(21) Appl. No.: 15/249,636

(22) Filed: Aug. 29, 2016

(51) Int. Cl. G06F 19/00

(52) U.S. Cl. CPC G06F 19/322; G06F 19/3418

(57) ABSTRACT

The disclosed embodiments illustrate methods and systems to recommend medical intervention activities for caregivers and/or human subjects. The method comprises receipt of medical data of a human subject and contextual data of a plurality of caregivers of the human subjects. The medical data includes periodic physiological data of the human subject received in real-time. A customized ontology is generated, from a pre-determined ontology related to a medical condition, based on the received medical data and the contextual data. Thereafter, a recommendation of medical intervention activities is generated for at least one of the plurality of caregivers and/or the human subject, based on analysis of the generated customized ontology, caregiver profiles, the received contextual data, and the periodic physiological data. The generated recommendation is transmitted to computing devices of the at least one caregiver and/or the human subject.

### TECHNICAL FIELD

The presently disclosed embodiments are in general related to data processing for healthcare. The presently disclosed embodiments are particularly related to methods and systems that recommend medical intervention activities for caregivers and/or human subjects.

### BACKGROUND

Medical intervention required for a human subject, i.e. a patient, may be based on various factors, inter alia a type of illness of the human subject, an extent of mobility of the human subject, and/or location of treatment of the human subject. Treatment of a human subject with an acute illness may be conducted within an institutional healthcare facility by professional medical practitioners and experts. However, treatment and monitoring the health condition of a chronically ill human subject may be performed at the residence of the human subject by one or more caregivers with varying degrees of medical proficiency. For instance, the one or more caregivers may include a certified medical practitioner, a nurse, a family member, and/or a housekeeping assistant. Such chronically ill human subjects may require careful, continuous monitoring of their health conditions and appropriate medical intervention based on the monitoring. The medical intervention support provided by a caregiver may be limited by availability of the caregiver, the caregiver's knowledge of the current health condition of the human subject, and medical proficiency of the caregiver. Thus, there exists a need for a method and system to recommend medical intervention activities for caregivers and human subjects based on real-time monitoring of the human subjects and profiles of the caregivers.

Further, limitations and disadvantages of conventional and traditional approaches will become apparent to one skilled in the art by comparing described systems with some aspects of the present disclosure, as set forth in the remainder of the present application and with reference to the drawings.

### SUMMARY

According to embodiments illustrated herein, there is provided a method for data processing to recommend medical intervention activities for caregivers and/or human subjects. The method may include receipt of medical data of a human subject and contextual data of a plurality of caregivers of the human subject, by one or more transceivers in a computing device, over a communication network. The medical data may include at least periodic physiological data of the human subject that may be received from one or more sensors in real-time. Further, the contextual data of the plurality of caregivers may be received from one or more data sources. Based on the received medical data and the contextual data, one or more processors in the computing device may generate a customized ontology from a pre-determined ontology associated with a medical condition of a plurality of human subjects. Thereafter, a recommendation of one or more medical intervention activities may be generated for at least one caregiver from the plurality of caregivers and/or the human subject by the one or more processors. The generation of the recommendation may be based on analysis of the generated customized ontology, a plurality of caregiver profiles, the received contextual data of the plurality of caregivers, and the periodic physiological data of the human subject. Further, the generated recommendation may be transmitted to a first user-computing device of the at least one caregiver and/or a second user-computing device of the human subject, over the communication network, by the one or more transceivers.

According to embodiments illustrated herein, there is provided a system for data processing to recommend medical intervention activities for caregivers and/or human subjects. The system includes one or more processors and one or more transceivers. The one or more transceivers may be configured to receive medical data of a human subject and contextual data of a plurality of caregivers of the human subject, over a communication network. The medical data may include at least periodic physiological data of the human subject that may be received from one or more sensors in real-time. Further, the contextual data of the plurality of caregivers may be received from one or more data sources. The one or more processors may be configured to generate a customized ontology from a pre-determined ontology associated with a medical condition of a plurality of human subjects, based on the received medical data and the contextual data. The one or more processors may be further configured to generate recommendation of one or more medical intervention activities for at least one caregiver from the plurality of caregivers and/or the human subject by the one or more processors. The generation of the recommendation may be based on analysis of the generated customized ontology, a plurality of caregiver profiles, the received contextual data of the plurality of caregivers, and the periodic physiological data of the human subject. The one or more transceivers may be further configured to transmit the generated recommendation to a first user-computing device of the at least one caregiver and/or a second user-computing device of the human subject, over the communication network.

According to embodiments illustrated herein, there is provided a computer program product for use with a computing device. The computer program product comprises a non-transitory computer readable medium storing a computer program code for data processing to recommend medical intervention activities for caregivers and/or human subjects. The computer program code is executable by one or more processors in the computing device to receive medical data of a human subject and contextual data of a plurality of caregivers of the human subject, by one or more transceivers in the computing device, over a communication network. The medical data may include at least periodic physiological data of the human subject that may be received from one or more sensors in real-time. Further, the contextual data of the plurality of caregivers may be received from one or more data sources. The computer program code is further executable to generate a customized ontology from a pre-determined ontology associated with a medical condition of a plurality of human subjects, based on the received medical data and the contextual data. In addition, the computer program code is further executable to generate a recommendation of one or more medical intervention activities for at least one caregiver from the plurality of caregivers and/or the human subject. The generation of the recommendation may be based on analysis of the generated customized ontology, a plurality of caregiver profiles, the received contextual data of the plurality of caregivers, and the periodic physiological data of the human subject. The computer program code may be further executable to transmit the generated recommendation a first user-computing device of the at least one caregiver and/or a second user-computing device of the human subject, over the communication network, by use of the one or more transceivers.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram of a system environment, in which various embodiments can be implemented;

FIG. 2 is a block diagram that illustrates a system for data processing to recommend medical intervention activities for caregivers and/or human subjects in accordance with at least one embodiment;

FIG. 3A is a flowchart that illustrates a method for data processing to recommend medical intervention activities for caregivers and/or human subjects in accordance with at least one embodiment;

FIG. 3B is a flowchart that illustrates a method for transmission of handover reports to caregivers in accordance with at least one embodiment;

FIG. 3C is a flowchart that illustrates another method for transmission of handover reports to caregivers in accordance with at least one embodiment;

FIG. 4 is a diagram that illustrates an exemplary interface of an exemplary ontology editor and/or interactive development environment (IDE) for generation, view, edit, and/or customization of an ontology, in accordance with at least one embodiment;

FIG. 5 is a diagram that illustrates a user-interface of a dashboard report of a human subject in accordance with at least one embodiment; and

FIG. 6 is a diagram that illustrates a user-interface for presentation of profile information of caregivers and administration of caregiver roles for a human subject, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “computing device” refers to a device that includes one or more processors/microcontrollers and/or any other electronic components, a device, or a system that performs one or more operations according to one or more programming instructions/codes. Examples of the computing device may include, but are not limited to, a desktop computer, a laptop, a personal digital assistant (PDA), a mobile device, a smartphone, and a tablet computer (e.g., iPad® and Samsung Galaxy Tab®).

A “wearable computing device” refers to a computing device that may be worn by an individual. A wearable computing device may include one or more sensors capable of monitoring various physiological parameters and related information of a human subject who wears the wearable computing device in real time. Examples of such physiological parameters and related information may include, but are not limited to, activity trend, rest, and sleep information. Examples of the wearable computing device may include, but are not be limited to, a smartwatch (e.g., Apple iWatch®, Samsung Gear S2®, Fitbit® smartwatch, Pebble® smartwatch, and Moto 360® smartwatch), a smart-band, a fitness band, a wrist band, an arm band, and smart-glasses (e.g., Google Glasses®).

A “Data Acquisition (DAQ) device” refers to a device that may gather signals from an external stimulus and generate output usable by a computing device for further processing. For example, a DAQ device may correspond to a temperature sensor that measures the surface temperature of a substrate and generates a corresponding temperature reading for further processing by a computing device.

“Medical data” refers to at least periodic physiological data of a human subject measured in real time. In an instance, the periodic physiological data of the human subject may be generated by a wearable computing device of the human subject. Examples of the information related to the human subject that is included in the periodic physiological data may include, but may not be limited to, one or more physiological parameters, physical activity trend data, medicine and food intake data, and/or sleep and rest data. The medical data may further include historical medical record data of the human subject received from one or more memory devices (such as one or more memory units of a human subject computing device, an application server, and a database server).

“Contextual data” refers to details of each of a plurality of caregivers associated with the human subject retrieved from one or more data sources. The one or more data sources may include one or more caregiver computing devices, social media servers, and/or one or more sensors. Examples of the contextual data of a caregiver may include, but may not be limited to, medical knowledge and caregiving skill sets, locational availability, calendar activity, and/or one or more social media updates.

“Biosensor” refers to a DAQ device that can be used to measure one or more physiological parameters of a human subject. Examples of a biosensor include, but are not limited to, a pressure/pulse sensor (to measure blood pressure and heart rate), a temperature sensor (to measure body temperature), a blood sample analyzer (to measure readings of various blood tests such as creatinine level, albumin level, sodium level, total blood count, glucose/sugar level, hemoglobin level, platelet count, and cholesterol level), a breath analyzer (to measure carbon dioxide/oxygen concentration in breath).

A “human subject” corresponds to a human being who may have a health condition or a disease. In an embodiment, the human subject may correspond to a person who seeks a medical opinion on his/her health condition.

A “caregiver” corresponds to an individual who may provide medical intervention support to a human subject. A caregiver may be of different types based on his/her medical proficiency and location. Examples of caregivers associated with the human subject may include, but may not be limited to, a housekeeping worker associated with the human subject, a resident or non-resident family member of the human subject, a resident or non-resident nursing assistant, and/or a registered nurse, a medical expert or a medical practitioner.

A “health condition” corresponds to a state of health of a human subject that may be characterized by whether or not the human subject suffers from an ailment (such as a chronic or acute illness) and the current extent or stage of the ailment.

A “medical intervention activity” corresponds to an activity that may be performed by a caregiver of a human subject or the human subject himself/herself to improve the health of the human subject or stop the condition of the human subject from deteriorating further.

A “healthcare facility” refers to an institutional setup that provides medical help to human subjects in the form of consultation from medical experts, in-patient or surgical medical facilities, out-patient prescription-based medical facilities, or home-care support by certified caregivers associated with the healthcare facility.

“Ontology” refers to a hierarchical organization of knowledge base associated with a particular knowledge domain, such as medical. The ontology may be categorized as a customized ontology and a pre-determined ontology associated with the health condition of a plurality of human subjects. The customized ontology may be generated from the pre-determined ontology retrieved from a local data source or a remote data source of a computing device such as an application server. The retrieval of the pre-determined ontology may be based on the historic medical record data of a human subject included within the medical data of the human subject. For instance, one or more pre-determined ontologies may be defined for different medical conditions associated with the plurality of human subjects and stored in the local data source or the remote data source. An example of such pre-determined ontology may be the one defined for human subjects with Diabetes Type-II.

A “social media platform” refers to a communication medium through which a user may interact with one or more other users who are known to or otherwise acquainted with the user. Apart from interacting with one another, the user and the one or more other users may post one or more messages on the social media platform.

Thereafter, the one or more users may interact with one another in reference to the one or more messages. Examples of social media platforms include, but are not limited to, social networking websites (e.g., Facebook™, Twitter™, LinkedIn™, and Google+™) web blogs, web forums, community portals, online communities, and online interest groups.

A “Decision Support System” (DSS) refers to an application program that may run on a computing device, such as an application server, and may be used in an organization to analyze operational, customer, and/or market data for informed decision-making based on the analysis. For instance, a DSS may be used in a healthcare facility to make several decisions associated with in-patients or out-patients of the healthcare facility.

A “message template” may refer to a notification wrapper that may be used to transmit notifications to one or more caregiver computing devices and/or a human subject computing device. In an instance, the message template may be used to transmit pull- or push-based notifications to the caregiver computing devices, when the periodic physiological data is received or the recommendation of medical intervention activities of the human subject is generated.

A “dashboard report” may refer to a report of a human subject that may be viewed through a user interface of a DSS (e.g., a DSS of a healthcare facility). The dashboard report may be used to make informed decisions related to the treatment course of the human subject. The dashboard report may be rendered based on a generated recommendation of medical intervention activities associated with the human subject and/or periodic physiological data related to the human subject.

A “handover report” may refer to a report generated for a second caregiver based on a type and/or a profile of the second caregiver. The second caregiver may correspond to a caregiver who may take over medical intervention activities associated with the human subject from a first caregiver.

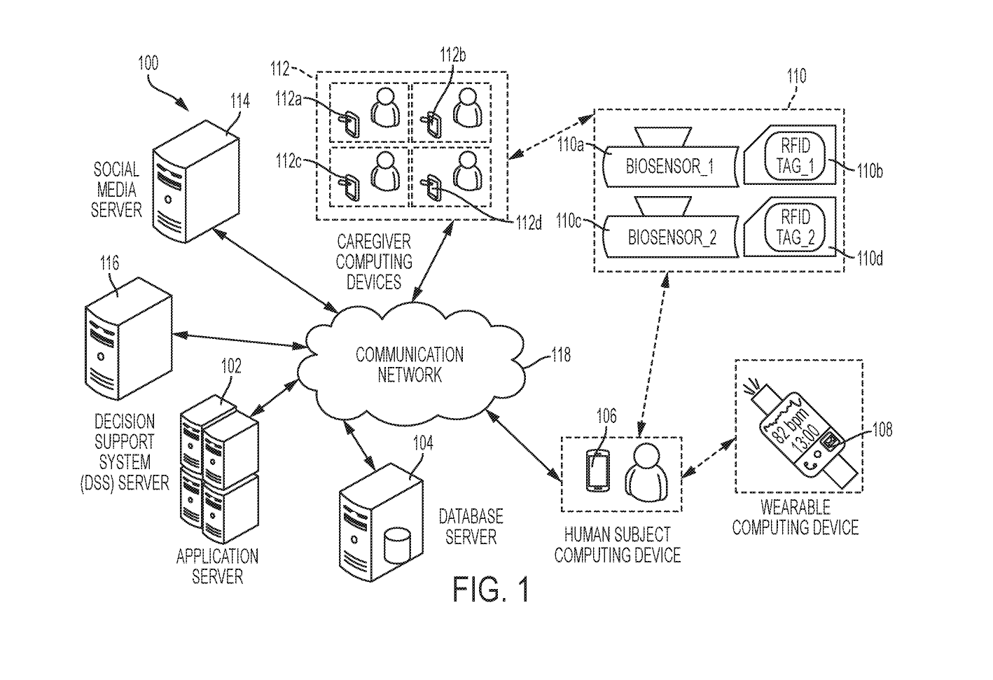

FIG. 1 is a block diagram of a system environment in which various embodiments may be implemented. FIG. 1 depicts a system environment 100. The system environment 100 includes an application server 102, a database server 104, a human subject computing device 106, one or more caregiver computing devices 112, a social media server 114, a decision support system (DSS) server 116, and a communication network 118. The various devices of the system environment 100 may be communicatively coupled through the communication network 118.

In addition, the system environment 100 may also include a wearable computing device 108 and one or more sensors 110. The one or more sensors 110 may include one or more biosensors (e.g., a biosensor_1 110a and a biosensor_2 110c) and one or more RFID tags (e.g., an RFID tag_1 110b and an RFID tag_2 110d). The one or more caregiver computing devices 112 may include, for example, a first caregiver computing device 112a, a second caregiver computing device 112b, a third caregiver computing device 112c, and a fourth caregiver computing device 112d. The wearable computing device 108 may be communicatively paired to the human subject computing device 106. Further, the one or more sensors 110 may be communicatively paired to the human subject computing device 106 and/or the one or more computing devices from the one or more caregiver computing devices 112.

In an embodiment, the application server 102 may refer to a computing device or a software framework hosting an application or a software service. In an embodiment, the application server 102 may be implemented to execute procedures such as, but not limited to, programs, routines, or scripts stored in one or more memory units to support the hosted application or the software service. In an embodiment, the hosted application or the software service may be configured to perform one or more predetermined data processing operations.

In an embodiment, the application server 102 may be configured to recommend medical intervention activities for caregivers and/or human subjects. The application server 102 may receive medical data of a human subject from the one or more sensors 110, the human subject computing device 106 of the human subject or a computing device of a caregiver (e.g., the first caregiver computing device 112a) of the human subject. The medical data may include at least periodic physiological data of the human subject measured in real time. In an embodiment, the periodic physiological data of the human subject may be generated by the wearable computing device 108 of the human subject. Examples of the information related to the human subject that is included in the periodic physiological data may include, but may not be limited to, one or more physiological parameters, physical activity trend data, medicine and food intake data, and/or sleep and rest data. The medical data may include historical medical record data of the human subject received from one or more memory devices (such as one or more memory units of the human subject computing device 106, the application server 102 or the database server 104). Apart from receipt of the medical data of the human subject, the application server 102 may also receive contextual data of each of a plurality of caregivers associated with the human subject from one or more data sources. The one or more data sources may include the one or more caregiver computing devices 112, the social media server 114, and/or the one or more sensors 110. In an embodiment, the contextual data of a caregiver may include, but may not be limited to, a medical knowledge and patient-caregiving skill set, locational availability, calendar activity, and/or one or more social media updates of the caregiver.

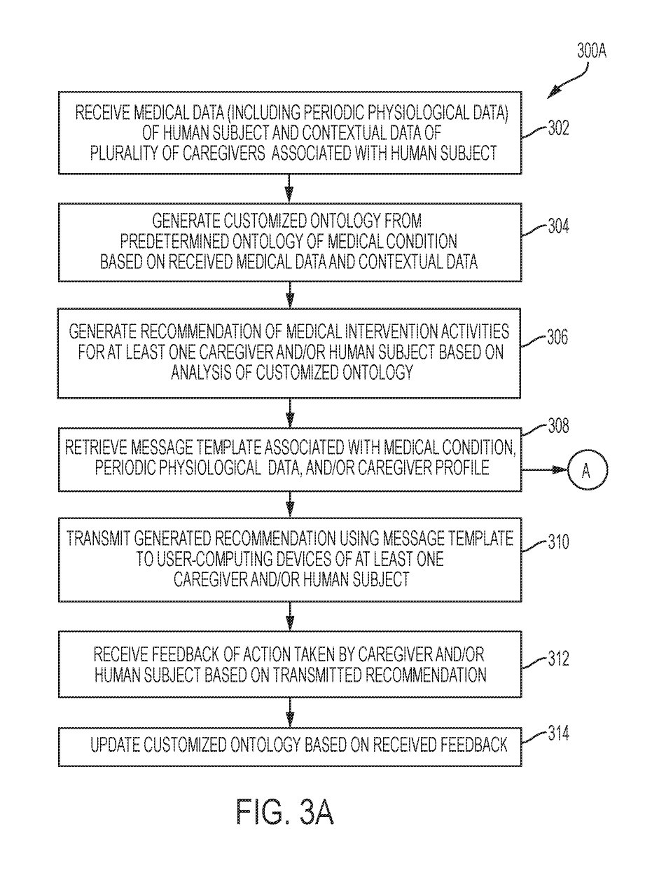

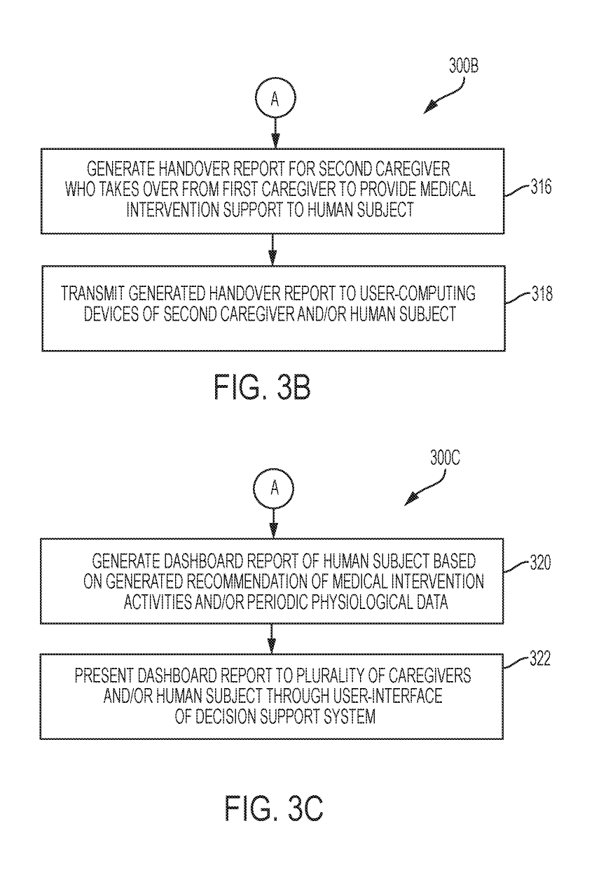

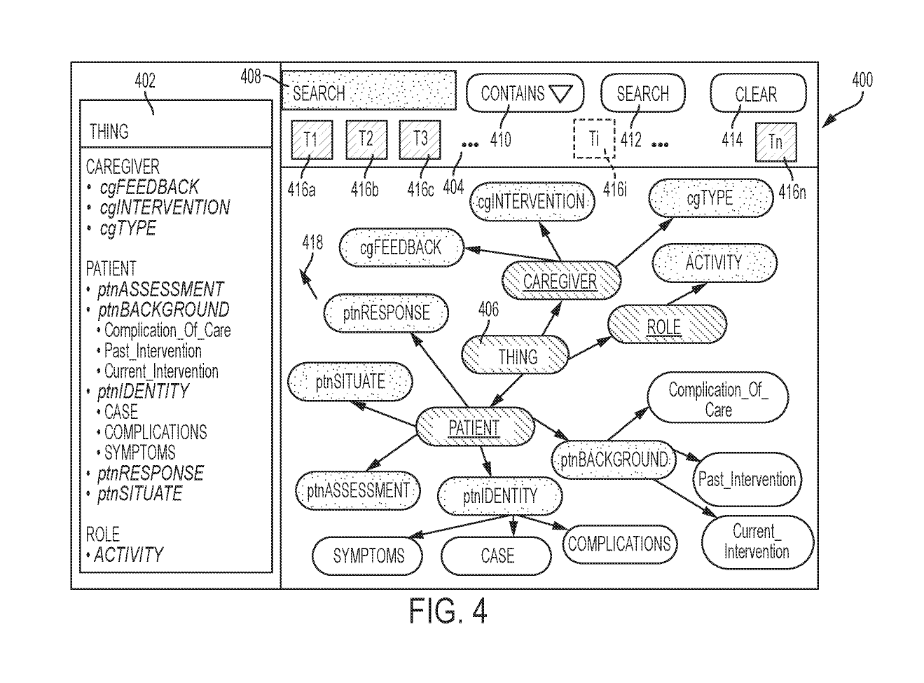

Further, the application server 102 may retrieve a pre-determined ontology from the database server 104 or one or more memory units of the application server 102. The pre-determined ontology may be associated with the medical condition of a plurality of human subjects. The application server 102 may be configured to generate a customized ontology from the pre-determined ontology based on the received medical data of the human subject and the contextual data of each of the plurality of caregivers associated with the human subject. Thereafter, in an embodiment, the application server 102 may generate a recommendation of one or more medical intervention activities of at least one caregiver from the plurality of caregivers and/or the human subjects. The generation of the recommendation may be based on an analysis of the generated customized ontology, a plurality of caregiver profiles, the received contextual data of the plurality of caregivers, and the periodic physiological data of the human subject. In an embodiment, the application server 102 may be configured to retrieve a message template from the database server 104 or one or more memory units of the application server 102 for transmission of the recommendation to a caregiver and/or the human subject. The message template may be associated with the health condition of the human subject, the periodic physiological data associated with the human subject, and/or profiles of the plurality of caregivers. Further, the generated recommendation may be transmitted by the application server 102 to a caregiver computing device (e.g., the first caregiver computing device 112a) and/or the human subject computing device 106. An embodiment of an exemplary method for generation and transmission of a recommendation of medical intervention activities for a caregiver and/or a human subject has been explained in conjunction with FIG. 3A. Further, an exemplary interface of an exemplary web ontology language (OWL)-based ontology editor and/or IDE has been explained in conjunction with FIG. 4. The exemplary ontology editor of FIG. 4 may be used to generate, view, edit, and customize an ontology.

After transmission of the recommendation, the application server 102 may receive feedback from one or more computing devices, such as a caregiver computing device (e.g., the first caregiver computing device 112a) and/or the human subject computing device 106. The feedback may correspond to an indication of an action taken by a caregiver and/or the human subject based on the transmitted recommendation. In response to the received feedback, the application server 102 may update the customized ontology in an embodiment. An embodiment of an exemplary method for updating the customized ontology based on the received feedback has been explained in conjunction with FIG. 3A.

In addition, in an embodiment, the application server 102 may also be configured to generate a handover report for a second caregiver based on a type and/or a profile of the second caregiver. The second caregiver may correspond to a caregiver who may take over medical intervention activities associated with the human subject from a first caregiver. The handover report generated by the application server 102 may be transmitted to a computing device of the second caregiver (e.g., the second caregiver computing device 112b) and/or the human subject computing device 106. In an embodiment, the handover report may also be transmitted to a computing device of the first caregiver (e.g., the first caregiver computing device 112a). An embodiment of an exemplary method for transmission of the handover report has been explained in conjunction with FIG. 3B.

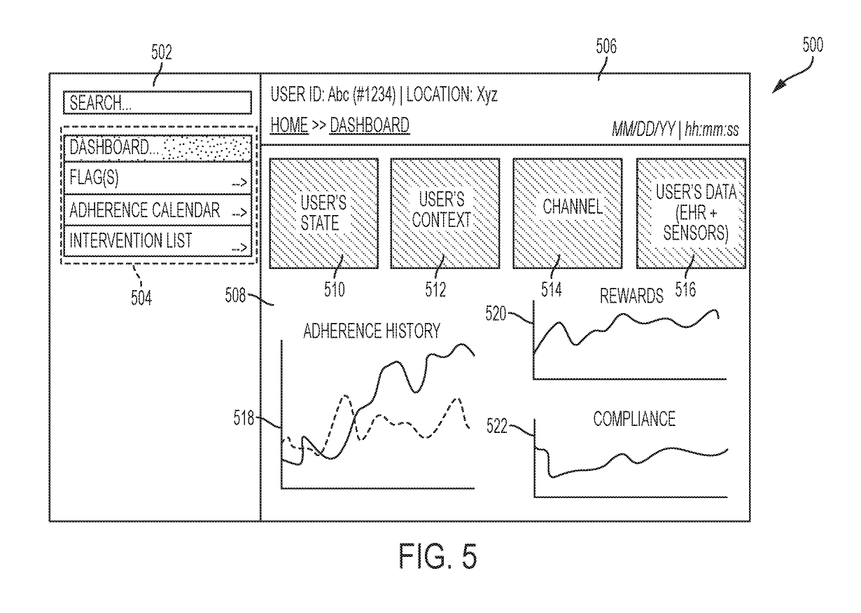

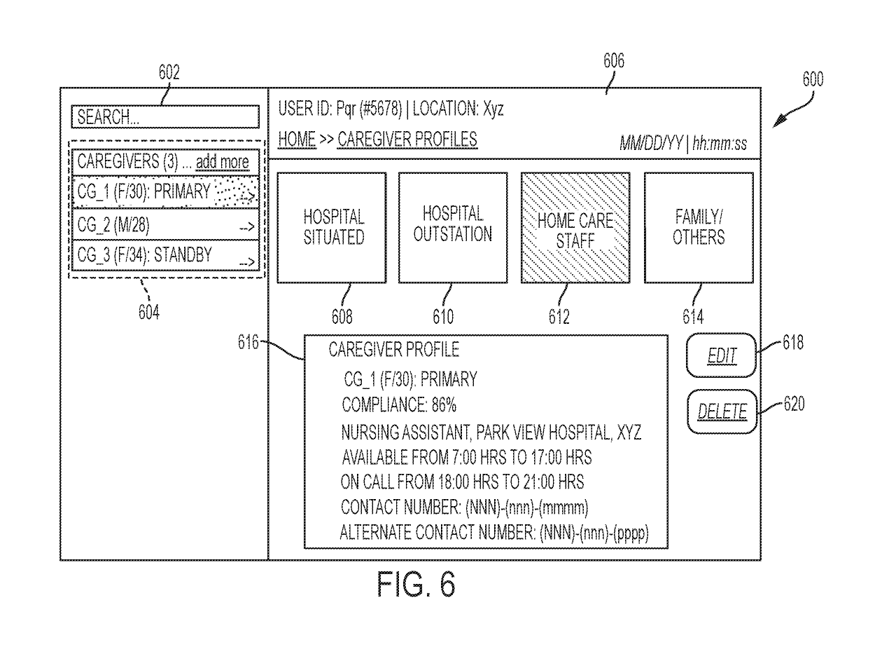

Further, in an embodiment, the application server 102 may be configured to generate a dashboard report associated with a decision support system (DSS), such as a DSS hosted by the DSS server 116. The application server 102 may generate the dashboard report based on the generated recommendation of the medical intervention activities associated with the human subject and/or the periodic physiological data. The application server 102 may present the dashboard report to the plurality of caregivers and/or the human subject through a user-interface of the DSS hosted by the DSS server 116. An embodiment of an exemplary method for generation and presentation of the dashboard report has been explained in conjunction with FIG. 3C. Further, an exemplary GUI of the dashboard report has been explained in conjunction with FIG. 5. An exemplary GUI of the user interface of the DSS to configure profile information of a caregiver of a human subject into the DSS has been explained in conjunction with FIG. 6.

The application server 102 may be realized through various types of application servers such as, but not limited to, a Java application server, a .NET framework application server, a Base4 application server, a PHP framework application server, or any other application server framework.

In an embodiment, the database server 104 may be configured to store the medical data of the human subject and the contextual data of the plurality of caregivers received by the application server 102, for further processing. In addition, the database server 104 may further store the pre-determined ontology associated with the health condition of the plurality of human subjects. The customized ontology associated with the human subject generated by the application server 102 based on the pre-determined ontology may also be stored in the database server 104 for further access by the application server 102. In an embodiment, the database server 104 may receive a query from the application server 102, the one or more caregiver computing devices 112, and/or the human subject computing device 106 to extract/store information from/in the database server 104. The database server 104 may be realized through various database technologies such as, but not limited to, Microsoft® SQL Server, Oracle®, IBM DB2®, Microsoft Access®, PostgreSQL®, MySQL®, and SQLite®. In an embodiment, the application server 102, the one or more caregiver computing devices 112, and/or the human subject computing device 106 may connect to the database server 104 using one or more protocols such as, but not limited to, Open Database Connectivity (ODBC) protocol and Java Database Connectivity (JDBC) protocol.

A person with ordinary skills in the art will understand that the scope of the disclosure is not limited to the database server 104 as a separate entity. In an embodiment, the functionalities of the database server 104 can be integrated into the application server 102, a computing device of a caregiver (e.g., the first caregiver computing device 112a), and/or the human subject computing device 106.

The human subject computing device 106 refers to a computing device used by a human subject. The human subject computing device 106 may include one or more processors and one or more memory units. The one or more memory units may include a computer readable code that is executable by the one or more processors to perform predetermined operations. In an embodiment, the human subject computing device 106 may be used by the human subject to provide the medical data to the application server 102 for generation of the recommendation of one or more medical intervention activities for a caregiver and/or the human subject. As discussed, the medical data may include the historical medical record data and the periodic physiological data of the human subject. In an embodiment, the historical medical record of the human subject may be stored in the one or more memory units of the human subject computing device 106. Further, in an embodiment, one or more physiological parameters associated with the periodic physiological data may be measured using the wearable computing device 108 and/or the one or more sensors 110. In an embodiment, the human subject may use the human subject computing device 106 to transmit the medical data of the human subject to the application server 102 and/or the database server 104 for further processing to generate an appropriate medical intervention activity recommendation. In an embodiment, the human subject computing device 106 may receive the recommendation of medical intervention activities associated with the human subject from the application server 102, for presentation to the human subject through the user interface of the human subject computing device 106. In addition, the human subject computing device 106 may also provide the human subject access to a dashboard report associated with the human subject through the DSS server 116.

The human subject computing device 106 may include a variety of computing devices such as, but not limited to, a laptop, a personal digital assistant (PDA), a tablet computer, a smartphone, and a phablet. A person skilled in the art will understand that the scope of the disclosure is not limited to the human subject computing device 106 and the application server 102 as separate entities. In an embodiment, the application server 102 may be realized as an application hosted on or running on the human subject computing device 106 without departing from the spirit of the disclosure.

In an embodiment, the wearable computing device 108 may correspond to a portable computing device capable of being worn by a user, such as the human subject. The wearable computing device 108 may include various sensors including, but not limited to, a heart rate sensor, a pulse sensor, a blood pressure sensor, a pedometer, a sleep monitoring sensor, and an accelerometer-based activity sensor. In an embodiment, the sensors associated with the wearable computing device 108 may (continuously or periodically) measure one or more of the physiological parameters and/or other information related to the periodic physiological data of the human subject. Information sensed by the wearable computing device 108 (i.e., the one or more physiological parameters and/or other information related to the periodic physiological data) is hereinafter referred to as sensor data of the wearable computing device 108. The wearable computing device 108 may transmit the sensed data of wearable computing device 108 to the human subject computing device 106 (for further forwarding), via a communicative link between the wearable computing device 108 and the human subject computing device 106. Alternatively, if the wearable computing device 108 is directly connected to the communication network 118, the wearable computing device 108 may transmit the sensor data of the wearable computing device 108 to the application server 102 and/or the database server 104. Examples of the wearable computing device 108 may include, but are not be limited to, a smartwatch (e.g., Apple iWatch®, Samsung Gear S2®, Fitbit® smartwatch, Pebble® smartwatch, Moto 360® smartwatch, etc.), a smart-band, a fitness band, a wrist band, an arm band, and smart-glasses (e.g., Google)Glasses®. In an embodiment, the wearable computing device 108 may communicate with the human subject computing device 106 using a wireless connection, such as, but not limited to, a Bluetooth-based connection, a Near Field Communication (NFC)-based connection, and a Radio Frequency Identification (RFID)-based connection.

In an embodiment, the one or more sensors 110 may be either inbuilt in the human subject computing device 106 or communicatively coupled to the human subject computing device 106 using a wired or wireless communication protocol. In addition, if a caregiver is situated near the human subject, the one or more sensors 110 may also be communicatively coupled to a computing device of the caregiver (e.g., the first caregiver computing device 112a) using a wired or wireless communication protocol. The one or more sensors 110 may include one or more biosensors (e.g., the biosensor_1 110a and the biosensor_2 110c) and one or more RFID tags (e.g., the RFID tag_1 110b and the RFID tag_2 110d). In an embodiment, the one or more biosensors (e.g., the biosensor_1 110a and the biosensor_2 110c) may refer to Data Acquisition (DAQ) devices utilized to gather various signals from the human subject and generate readings of one or more physiological parameters of the human subject in real time. Examples of the one or more physiological parameters include, but are not limited to, age, cholesterol level, heart rate/pulse, blood pressure, carbon dioxide concentration in breath, oxygen concentration in breath, stroke score, skin conductance level (or GSR), blood creatinine level, blood albumin level, blood sodium level, total blood count, blood glucose/sugar level, blood hemoglobin level, and blood platelet count. In an embodiment, the one or more biosensors (e.g., the biosensor_1 110a and the biosensor_2 110c) may be attached to a body of the human subject to measure the one or more physiological parameters. Examples of such biosensors (e.g., the biosensor_1 110a) include, but are not limited to, a blood pressure/pulse sensor or a temperature sensor. Alternatively, the one or more biosensors (e.g., the biosensor_2 110c) may correspond to one or more blood sample analyzers for analyzing a blood sample taken from the human subject to determine readings of one or more blood tests. In another embodiment, the one or more biosensors (e.g., the biosensor_1 110a and the biosensor_2 110c) may correspond to one or more breath analyzers for analyzing a breath sample of the human subject. Further, in an embodiment, the one or more RFID tags (e.g., the RFID tag_1 110b and the RFID tag_2 110d) may be attached to a body part of the human subject and one or more objects associated with medical intervention activities of the human subject. Examples of such objects may include, but may not be limited to, a bed, a medicine box, a water or juice container, a food consumption plate, and a medicine prescription note. The one or more RFID tags (e.g., the RFID tag_1 110b and the RFID tag_2 110d) may collect data such as activity trend of the human subject; food, water and medicine intake of the human subject; rest and sleep of the human subject; and compliance with the medical prescription by the human subject. A person skilled in the art will understand that the aforementioned biosensors and RFID tags are for exemplary purposes and should not be construed to limit the scope of the disclosure.

The one or more caregiver computing devices 112 may refer to computing devices used by a plurality of caregivers associated with a human subject. A caregiver computing device (e.g., the first caregiver computing device 112a) may include one or more processors and one or more memory units. The one or more memory units may include a computer readable code that is executable by the one or more processors to perform predetermined operations. In an embodiment, each caregiver associated with provision of medical intervention support to a human subject may be registered with the application server 102 using a computing device of the caregiver (e.g., the first caregiver computing device 112a). The contextual data of the caregiver may be tracked based on the caregiver's profile and activity updates (e.g., location, calendar activity, and social media feed) collected from the caregiver's computing device (e.g., the first caregiver computing device 112a) and/or the social media server 114. In an embodiment, the caregiver may receive pull or push notifications on the caregiver's computing device (e.g., the first caregiver computing device 112a) including recommendations of medical intervention activities associated with the human subject in a predetermined messaging template from the application server 102. In an embodiment, the application server 102 may generate the recommendations based on the contextual data of the caregiver, the medical data of the human subject, and the customized ontology associated with the human subject, as explained earlier. Based on the received recommendations, the caregiver may provide appropriate medical care or medical intervention support to the human subject.

In an embodiment, in a scenario when a caregiver is near the human subject, the computing device of the caregiver (e.g., the first caregiver computing device 112a) may be communicatively coupled to the one or more sensors 110 based on a wired or wireless communication protocol. In such a case, the caregiver may assist the human subject to use the one or more sensors 110 to generate the periodic physiological data of the human subject in real time. Thereafter, the computing device of the caregiver (e.g., the first caregiver computing device 112a) may receive the periodic physiological data of the human subject from the one or more sensors 110, which may then be forwarded to the application server 102 and/or the database server 104. Further, in an embodiment, a caregiver may receive a handover report associated with handover of medical intervention support responsibilities associated with the human subject from the application server 102 on a computing device of the caregiver (e.g., the first caregiver computing device 112a). In addition, a caregiver computing device (e.g., the first caregiver computing device 112a) may also be provide the caregiver access to a dashboard report associated with the human subject through the DSS server 116.

The one or more caregiver computing devices 112 may include a variety of computing devices such as, but not limited to, a laptop, a personal digital assistant (PDA), a tablet computer, a smartphone, and a phablet. A person skilled in the art will understand that the scope of the disclosure is not limited to a caregiver computing device (e.g., the first caregiver computing device 112a) and the application server 102 as separate entities. In an embodiment, the application server 102 may be realized as an application hosted on or running on the caregiver computing device (e.g., 112a) without departing from the spirit of the disclosure.

In an embodiment, the social media server 114 may refer to a computing device or a software framework hosting an application or a software service. In an embodiment, the social media server 114 may be implemented to execute procedures such as, but not limited to, programs, routines, or scripts stored in one or more memory units to support the hosted application or the software service. In an embodiment, the hosted application or the software service may be configured to perform one or more predetermined operations. In an embodiment, the social media server 114 may host a social media platform that may correspond, but may not be limited to, a social networking website (e.g., Facebook™, Twitter™, LinkedIn™, Google+™, etc.), a blog, a web forum, a community portal, an online community, or an online interest group. In an embodiment, the social media platform may include a plurality of registered members who may communicate with one or more other acquainted or unknown members of the social media platform through the social media platform. Further, the plurality of registered members may post one or more status updates as social media feed, through the social media platform for broadcast to other members of the social media platform. Examples of the one or more social media updates may include, but may not be limited to, comments, likes, or dislikes to a message thread; upload of pictures, videos, or other files (e.g., multimedia content); initiation of new message threads; and check-ins or location updates, current activities, and/or calendar events. In an embodiment, the human subject and/or or one or more of the plurality of caregivers may be registered as members of the social media platform. The human subject and/or the one or more caregivers may post one or more social media updates on the social media platform by using their respective computing devices (e.g., the human subject computing device 106 and/or the one or more caregiver computing devices 112). In an embodiment, the application server 102 may periodically pull the one or more social media updates of the one or more caregivers from the social media server 114. These one or more social media updates of the one or more caregivers may correspond to the contextual data of the one or more caregivers.

A person with ordinary skills in the art will understand that the scope of the disclosure is not limited to the application server 102 and the social media server 114 as separate entities. In an embodiment, the application server 102 and the social media server 114 may be combined into a single entity and may be implemented by the same server.

In an embodiment, the DSS server 116 may refer to a computing device or a software framework hosting an application or a software service. In an embodiment, the DSS server 116 may be implemented to execute procedures such as, but not limited to, programs, routines, or scripts stored in one or more memory units to support the hosted application or the software service. In an embodiment, the hosted application or the software service may be configured to perform one or more predetermined operations. In an embodiment, The DSS server 116 may host an application that may assist an institutional healthcare facility, the one or more caregivers, and/or the human subject to make informed decisions related to medical intervention and course of treatment of the human subject. The DSS server 116 may work in conjunction with the application server 102 to provide dashboard-based reports to users (such as caregivers, healthcare facility administrators, and/or the human subject) regarding the medical intervention and treatment plan for the human subject.

A person with ordinary skills in the art will understand that the scope of the disclosure is not limited to the application server 102 and the DSS server 116 as separate entities. In an embodiment, the application server 102 and the DSS server 116 may be combined into a single entity and implemented by the same server.

The communication network 118 corresponds to a medium through which content and messages flow between various devices of the system environment 100 (e.g., the application server 102, the database server 104, the human subject computing device 106, the one or more caregiver computing devices 112, the social media server 114, and/or the DSS server 116). Examples of the communication network 118 may include, but are not limited to, a wireless fidelity (Wi-Fi) network, a wireless area network (WAN), a local area network (LAN), or a metropolitan area network (MAN). Various devices in the system environment 100 can connect to the communication network 118 in accordance with various wired and wireless communication protocols such as transmission control protocol and internet protocol (TCP/IP), user datagram protocol (UDP), and 2G, 3G, LTE, LTE-Advanced (4G), or 5G communication protocols.

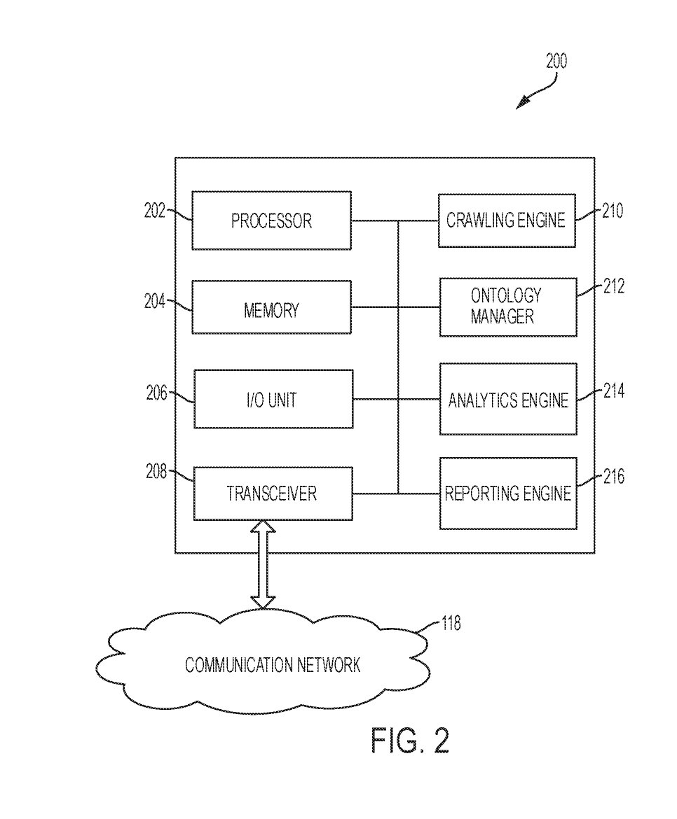

FIG. 2 is a block diagram that illustrates a system for data processing to recommend medical intervention activities for caregivers and/or human subjects, in accordance with at least one embodiment. With reference to FIG. 2, a system 200 is depicted that may correspond to the application server 102, the human subject computing device 106, or a computing device of a caregiver (e.g., the first caregiver computing device 112a). For the purpose of ongoing description, the system 200 is considered as the application server 102. However, the scope of the disclosure should not be limited to the system 200 as the application server 102. The system 200 may also be realized as the human subject computing device 106 or a computing device of a caregiver (e.g., the first caregiver computing device 112a), without departure from the scope of the disclosure.

The system 200 includes one or more processors, such as a processor 202, one or more memory units, such as a memory 204, one or more input/output (I/O) units, such as an I/O unit 206, and one or more transceivers, such as a transceiver 208. The system 200 may further include a crawling engine 210, an ontology manager 212, an analytics engine 214, and a reporting engine 216. The transceiver 208 may be connected to the communication network 118.

The processor 202 may be configured to execute one or more sets of instructions, codes, scripts, and programs stored in the memory 204. The processor 202 is coupled to the memory 204, the I/O unit 206, the transceiver 208, the crawling engine 210, the ontology manager 212, the analytics engine 214, and the reporting engine 216. The processor 202 may execute the one or more sets of instructions, codes, scripts, and programs stored in the memory 204 to perform the one or more associated operations. The processor 202 may be implemented based on a number of processor technologies known in the art. Examples of the processor 202 include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs with at least one code section executable by the processor 202. The memory 204 may store the one or more sets of instructions, codes, scripts, and programs. Some of the commonly known memory implementations include, but are not limited to, a random access memory (RAM), a read-only memory (ROM), a hard disk drive (HDD), and a secure digital (SD) card. In an embodiment, the memory 204 may include the one or more machine codes, and/or computer programs that may be executable by the processor 202 to perform specific operations. It will be apparent to a person with ordinary skill in the art that the one or more sets of instructions, codes, scripts, and programs stored in the memory 204 may enable the hardware of the system 200 to perform the one or more associated operations.

The I/O unit 206 may comprise suitable logic, circuitry, interfaces, and/or code that may be operable to receive one or more inputs from one or more users of the system 200 and present one or more outputs to the one or more users. The I/O unit 206 may be operable to communicate with the processor 202 to receive the one or more inputs and provide the one or more outputs. Examples of the input devices corresponding to the I/O unit 206 may include, but are not limited to, a touch screen, a keyboard, a mouse, a joystick, a microphone, a camera, a motion sensor, a light sensor, and/or a docking station. Examples of the output devices corresponding to the I/O unit 206 may include, but are not limited to, a display device (e.g., a LCD screen, a LED screen, CRT screen), a projector, and/or a printer.

The transceiver 208 may be operable to communicate with the one or more devices, such as the human subject computing device 106 and/or the one or more caregiver computing devices 112, via the communication network 118. Further, the transceiver 208 may also be operable to communicate with one or more servers, such as the database server 104, the social media server 114, and the DSS server 116, via the communication network 118. The transceiver 208 may be configured to receive a request from a user (e.g., a caregiver of a human subject) of a caregiver computing device (e.g., the first caregiver computing device 112a) via the communication network 118, for recommendations related to medical intervention activities associated with the human subject. Based on the request, in conjunction with the processor 202, the transceiver 208 may be configured to receive medical data of the human subject from the one or more sensors 110 and/or the wearable computing device 108 via the human subject computing device 106 in real time. In an embodiment, the medical data of the human subject may include the periodic physiological data of the human subject and historical medical record data of the human subject. In an embodiment, the periodic physiological data may be received from the human subject computing device 106, while the historical medical record data may be received from the database server 104 (that may also store the historical medical record data of multiple human subjects). In addition to the receipt of the medical data of the human subject in real time, the transceiver 208, in conjunction with the processor 202, may also be configured to receive the contextual data of the plurality of caregivers associated with the human subject from one or more data sources. In an embodiment, the one or more data sources may comprise the respective computing device of each of the plurality of caregivers (e.g., the first caregiver computing device 112a), the database server 104, and/or the social media server 114. Thereafter, the transceiver 208 may be configured to transmit the received medical data of the human subject and contextual data of the plurality of caregivers to the processor 202 for further processing to generate recommendations of medical intervention activities associated with the human subject.

Further, in conjunction with the processor 202, the transceiver 208 may be configured to transmit the generated recommendations to the human subject computing device 106 and/or the one or more caregiver computing devices 112. In addition, in conjunction with the processor 202, the transceiver 208 may be configured to transmit the handover report to a computing device of a relevant caregiver associated with the human subject (e.g., the first caregiver computing device 112a). Further, in conjunction with the processor 202, the transceiver 208 may be configured to transmit the information related to the dashboard report to the DSS server 116 for presentation to a user of the DSS.

Examples of the transceiver 208 may include, but are not limited to, an antenna, an Ethernet port, a USB port, or any other port that can be configured to receive and transmit data. The transceiver 208 may receive and transmit data/information in accordance with the various communication protocols, such as TCP/IP, UDP, and 2G, 3G, LTE, LTE-Advanced (4G), or 5G communication protocols, through an input terminal and an output terminal, respectively, over the communication network 118.

The crawling engine 210 may comprise suitable logic, circuitry, interfaces, and/or code that may be operable to execute one or more sets of instructions, codes, scripts, and programs stored in the memory 204. The crawling engine 210 may be realized by use of one or more algorithms to implement a web crawler or Internet bot to scan one or more websites, extract data and links associated with the one or more scanned websites, and check recency of the data and links. The crawling engine 210 may be configured to extract the one or more social media updates associated with the contextual data of the plurality of caregivers of the human subject from the social media platform hosted by the social media server 114. The crawling engine 210 may also extract information pertaining to a caregiver profile of each of the plurality of caregivers based on the scanned one or more Internet websites. In an embodiment, the crawling engine 210 may search for one or more websites that correspond to the DSS and extract information pertaining to the human subject including the historical medical record data from the one or more websites of the DSS. Thus, the historical medical record data may not be required to be pulled from the database server 104 in case this information is found on the one or more Internet websites of the DSS.

In an embodiment, the crawling engine 210 may be implemented using various known web crawling techniques such as, but not limited to, a URL frontier set, a DNS resolution module, a page fetch module, a web parsing module, a duplicate elimination module. The crawling engine 210 may be implemented based on a number of processor technologies known in the art. Examples of the crawling engine 210 may include, but may not be limited to, an X86-based processor, a RISC processor, an ASIC processor, and/or a CISC processor.

The ontology manager 212 may comprise suitable logic, circuitry, interfaces, and/or code that may be operable to execute one or more sets of instructions, codes, scripts, and programs stored in the memory 204. The ontology manager 212 may be realized by use of one or more mathematical models, entity-relationship models, and/or one or more algorithms. The ontology manager 212 may be configured to extract a pre-determined ontology associated with health condition of a plurality of human subjects (e.g., a generic ontology of human subjects suffering from Type-II Diabetes) from the database server 104 or the memory 204. The extraction of the pre-determined ontology may be based on the historical medical data of the human subject. For instance, the pre-determined ontology corresponding to Type-II Diabetes may be extracted if the historical medical data of the human subject are indicative of a chronic Type-II Diabetes health condition. Thereafter, the ontology manager 212 may be configured to generate a customized ontology associated with the human subject based on the medical data (including the periodic physiological data collected in real time) and contextual data of the plurality of caregivers of the human subject. In addition, in an embodiment, the ontology manager 212 may be configured to update the ontology based on feedback received from caregivers and/or human subjects, in response to the transmitted recommendations of medical intervention activities.

In an embodiment, the ontology manager 212 may maintain the ontology based on a subject-predicate-object association between the human subject, the plurality of caregivers, and/or a plurality of medical intervention activities associated with the human subject. The customized ontology may be utilized to generate one or more handover reports personalized for the at least one caregiver. The customized ontology may correspond to a standard medical communication framework utilized for case management and clinical handover reports. An example of such framework may be an Identify-Situate-Background Check-Assessment-Response and rationale (ISBAR) framework. The ontology manager 212 may be implemented based on a number of processor technologies known in the art.

The analytics engine 214 may involve suitable logic, circuitry, interfaces, and/or code that may be operable to execute one or more sets of instructions, codes, scripts, and programs stored in the memory 204. The analytics engine 214 may be realized by the use of one or more mathematical models, one or more statistical models, one or more algorithms, and/or one or more trigger rules. The analytics engine 214 may be configured to generate pull or push notifications including the recommendations of one or more medical intervention activities for caregivers and/or human subjects. The recommendations may be generated based on the medical data including the periodic physiological data of the human subject received in real time and the contextual data of the caregivers. The notifications may be transmitted based on a message template associated with the health condition of the human subject, the periodic physiological data, and/or caregiver profile of the caregivers. In addition, the analytics engine 214 may also be configured to generate the handover report for a caregiver in response to a request for the handover report. The request for the handover report may be received from a respective computing device of the caregiver (e.g., 112a), the human subject (i.e., 106), and/or another caregiver (e.g., 112b) associated with the handover. Further, the analytics engine 214 may be configured to generate a dashboard report associated with the human subject for presentation to users of the DSS. The dashboard report may be generated based on a request received from the DSS server 116, in response to a request by a user of the DSS.

The analytics engine 214 may be implemented based on a number of processor technologies known in the art. Examples of the analytics engine 214 may include, but may not be limited to, an X86-based processor, a RISC processor, an ASIC processor, and/or a CISC processor.

The reporting engine 216 may involve suitable logic, circuitry, interfaces, and/or code that may be operable to execute one or more sets of instructions, codes, scripts, and programs stored in the memory 204. The reporting engine 216 may be realized by use of one or more algorithms and/or one or more trigger rules. The reporting engine 216 may be configured to transmit pull or push notifications including the recommendations of one or more medical intervention activities for caregivers and/or human subjects. The recommendations may be generated by the analytics engine 214 based on the medical data including the periodic physiological data of the human subject received in real time and the contextual data of the caregivers. The reporting engine 216 may generate notifications for transmission based on a pre-determined message template format extracted from the database server 104 or the memory 204. The extraction of the pre-determined message template format may be based on the health condition of the human subject, the periodic physiological data, and/or caregiver profile of the caregivers. In addition, the reporting engine 216 may also be configured to transmit the handover report for a caregiver, generated by the analytics engine 214, to a computing device of the caregiver (e.g., the first caregiver computing device 112a). Further, the reporting engine 216 may be configured to transmit information pertaining to a dashboard report, generated by the analytics engine 214, to the DSS server 116.

The reporting engine 216 may be implemented based on a number of processor technologies known in the art. Examples of the reporting engine 216 may include, but may not be limited to, an X86-based processor, a RISC processor, an ASIC processor, and/or a CISC processor.

In FIG. 2, the crawling engine 210, the ontology manager 212, the analytics engine 214, and/or the reporting engine 216 are depicted as independent from the processor 202. However, a person skilled in the art will appreciate that the crawling engine 210, the ontology manager 212, the analytics engine 214, and/or the reporting engine 216 may be implemented within the processor 202, without departing from the scope of the disclosure. Further, in an embodiment, the functionalities of one or more of the aforementioned modules may be implemented by a single module, without departing from the scope of the disclosure. For instance, the functionality of the reporting engine 216 may be implemented by the analytics engine 214, and the reporting engine 216 need not be realized as a separate module, and so on. In addition, a person skilled in the art will appreciate that the processor 202 may be configured to perform the functionalities of the crawling engine 210, the ontology manager 212, the analytics engine 214, and/or the reporting engine 216, without departing from the scope of the disclosure. An embodiment of operation of the system 200 to recommend medical intervention activities for the caregivers and/or the human subjects has been explained further in conjunction with FIG. 3A.

FIG. 3A is a flowchart that illustrates a method for data processing to recommend medical intervention activities for caregivers and/or human subjects, in accordance with at least one embodiment. With reference to FIG. 3A, there is shown a flowchart 300A that has been described in conjunction with FIG. 1 and FIG. 2. The flowchart 300A illustrates the method that starts at step 302.

At step 302, medical data of a human subject and contextual data of a plurality of caregivers associated with the human subject are received. In an embodiment, the transceiver 208, in conjunction with the processor 202, may be configured to receive the medical data of the human subject and the contextual data of the plurality of caregivers, via the communication network 118. In an embodiment, the medical data of the human subject may be received from the human subject computing device 106, the one or more sensors 110, the wearable computing device 108, and/or the database server 104. Further, the contextual data of each of the plurality of caregivers may be received from the one or more caregiver computing devices 112 (of the corresponding caregivers), the social media server 114, and/or the database server 104.

Medical data of the human subject: In an embodiment, the medical data of the human subject may include periodic physiological data and historical medical record data of the human subject. In an embodiment, the periodic physiological data may be generated in real time on a periodic basis. Examples of information included in the periodic physiological data associated with the human subject may include, but may not be limited to, a measure of one or more physiological parameters, activity data, food and medicine intake data, and/or sleep and rest data. In an embodiment, the one or more physiological parameters may include, but may not be limited to, age, cholesterol level, heart rate/pulse, blood pressure, breath carbon-dioxide concentration, breath oxygen concentration, stroke score, skin conductance level (or GSR), blood creatinine level, blood albumin level, blood sodium level, total blood count, blood glucose/sugar level, blood hemoglobin level, and blood platelet count. In an embodiment, the human subject may use the one or more biosensors (e.g., the biosensor_1 110a) and the wearable computing device 108 to measure the one or more physiological parameters in real time. Further, other information in the periodic physiological data (e.g., activity data, food and medicine intake data, and/or sleep and rest data) may be generated by the one or more RFID tags (e.g., the RFID tag_1 110b) and the wearable computing device 108, when used by the human subject during the course of a day (or night).

For instance, an RFID tag (e.g., the RFID tag_1 110b) may be provided on a medicine box that includes medicines prescribed to the human subject. Further, another RFID tag (e.g., the RFID tag_2 110d) may be provided on a dress worn by the human subject (or may be inbuilt within the wearable computing device 108). When the human subject opens the medicine box and removes a medicine from the medicine box, the two RFID tags (e.g., the RFID tag_1 110b on the medicine box and the RFID tag_2 110d on the dress) may detect a contact. Based on the detected contact, the medicine intake data may be detected.

In addition, the wearable computing device 108 may include sensors such as, but not limited to, accelerometer, pedometer, gyroscope, and gravity sensor. The wearable computing device 108 may use such inbuilt sensors to detect a pre-determined sequence of movements of the human subject to generate the food intake data. For instance, a particular hand motion of the human subject that may be performed repeatedly at a certain frequency for a particular period of time may be identified as corresponding to a food intake activity. The frequency of the hand motion and period of time for which the hand motion is detected may be used to determine a portion size of the food intake. Further, the type, speed, and frequency of hand motion may be used to determine the type of food being consumed, such as liquid, semi-solid, or solid. In an embodiment, the wearable computing device 108 may use one or more probabilistic or mathematical models to generate the food intake data based on an indicative measure of the portion size, type of food, and other food intake parameters captured by the sensors of the wearable computing device 108. In addition, similar to the food intake detection, the wearable computing device 108 may determine the activity data of the human subject based on a detection of a pre-determined body motion of the human subject. For instance, the wearable computing device 108 may use its inbuilt accelerometer and pedometer to detect whether the human subject is walking, and to determine the average step size of the human subject, walking/running speed of the human subject, and total distance covered by the human subject in a particular period, and so on.

In an embodiment, the information related to the periodic physiological data generated by the one or more sensors 110 and/or the wearable computing device 108 may be transmitted by the respective device to the human subject computing device 106. As discussed, the one or more sensors 110 and/or the wearable computing device 108 may be communicatively paired with the human subject computing device 106 using one or more wired or wireless communication protocols. The human subject computing device 106 may periodically collect this information from the one or more sensors 110 and/or the wearable computing device 108 and collate the received information as the periodic physiological data. Thereafter, the human subject computing device 106 may transmit the collated periodic physiological data to the application server 102 and/or the database server 104, via the communication network 118 for further processing.

A person skilled in the art will understand that the scope of the disclosure should not be limited to the transmission of the periodic physiological data by the human subject computing device 106. In an embodiment, at least one of the one or more sensors 110 and/or the wearable computing device 108 may be able to directly connect to the communication network 118, without departing from the spirit of the disclosure. In such a scenario, the one or more sensors 110 and/or the wearable computing device 108 may transmit information related to the periodic physiological data, which may be periodically generated by these devices, directly to the application server 102 and/or the database server 104. The application server 102 and/or the database server 104 may collate this periodically received information as the periodic physiological data associated with the human subject. In addition, the one or more sensors 110 and/or the wearable computing device 108 may also transmit the periodically generated information related to the periodic physiological data, to the human subject computing device 106 and/or the one or more caregiver computing devices 112.

Further, a person skilled in the art may understand that in certain scenarios, a caregiver computing device (e.g., the first caregiver computing device 112a) may be communicatively coupled to the one or more sensors 110. For instance, when the caregiver is near the bedside of the human subject, the caregiver may use the one or more sensors 110 to determine at least a portion of information related to the periodic physiological data of the human subject. The computing device of the caregiver (e.g., the first caregiver computing device 112a) may receive this portion of information from the one or more sensors 110. The caregiver computing device (e.g., 112a) may either forward this received portion of information directly to the application server 102 and/or the database server 104 or send this portion of information to the human subject computing device 106 for forwarding.

In an embodiment, the historical medical record data of the human subject may include, but may not be limited to, health log data (e.g., HL7 Electronic/Patient Health Records (EHR/PHR) of the human subject), signatory data (offline or online), periodic critical health records, self-recorded data, medical allergens data, and/or family history of health condition. In an embodiment, the historical medical record data of the human subject may be maintained and updated at the database server 104. The historical medical record data may be updated each time the human subject consults a medical practitioner, when the human subject is diagnosed with a health condition, or prescribed with a medicine. In another embodiment, the historical medical record data may also be maintained at the human subject computing device 106 or a computing device of a caregiver (e.g., the first caregiver computing device 112a), for instance, a medical practitioner. Thus, the historical medical record data of the human subject may either be received from the database server 104 or from the human subject computing device 106 by the application server 102.

Extraction of the medical data: In an embodiment, the periodic physiological data of the human subject may be uploaded periodically in real time by the human subject computing device 106 (or the one or more sensors 110 and/or the wearable computing device 108) on a web portal. The web portal may either be hosted by the application server 102 or the DSS server 116. Further, the historic medical record data of the human subject may either be stored on the database server 104, the human subject computing device 106, and/or a computing device of a caregiver of the human subject (e.g., the first caregiver computing device 112a). The historic medical record data of the human subject may also be uploaded on the aforementioned web portal hosted by the application server 102 or the DSS server 116, whenever there is change in the historic medical record data (or periodically). In an embodiment, the historic medical record data may be time stamped. The recentness and validity of the historic medical record data may be verified based on the time stamp. If the time stamp is recent (as compared with the newly uploaded periodic physiological data), the historic medical record data may not be required to be uploaded again on the web portal, until a certain period (e.g., two weeks, one month, or a new diagnosis/change in treatment).

In an embodiment, the crawling engine 210, in conjunction with the processor 202, may pull information related to the medical data (including the periodic physiological data and the historic medical record data) of the human subject by crawling the web portal. The information related to the medical data of the human subject may be pulled in response to an indication of a new upload of the periodic physiological data on the web portal. Alternatively, in a scenario where the medical data is not uploaded on the web portal, the processor 202 may periodically transmit a request to the human subject computing device 106 for the periodic physiological data in real time. In response to the request, the processor 202 may receive the physiological data from the one or more sensors 110, the wearable computing device 108, and/or the human subject computing device 106. Further, in case the historic medical record data is uploaded on the portal and determined as valid (as per its timestamp), the crawling engine 210, in conjunction with the processor 202, may extract the historic medical record data by crawling the web portal. Alternatively, if the historic medical record data is not uploaded on the portal but stored on the database server 104 (or the human subject computing device 106, and/or a caregiver computing device (e.g., 112a)), the processor 202 may transmit a request for the historic medical record data. In response to the transmitted request, the processor 202 may receive the historic medical record data from the database server 104 (or the human subject computing device and/or a caregiver computing device (e.g., 112a)). In another embodiment, the processor 202 may transmit a request for the historic medical record data in a manner similar to that explained above, when the historic medical record data is uploaded on the web portal but is invalid due as being non-recent.

Contextual data of the plurality of caregivers: In an embodiment, the contextual data of each of the plurality of caregivers may include medical knowledge and patient-caregiving skill set, locational availability, calendar activity, and/or one or more social media feeds, associated with the caregiver. In an embodiment, each caregiver's profile may be stored and maintained by the database server 104. In another embodiment, one or more memory units of the DSS server 116, the application server 102, and/or the social media server 114 may be configured to store and maintain the profile of each of the caregivers. For instance, if the DSS server 116 corresponds to a server that hosts a DSS application of a healthcare facility, the one or more memory units of the DSS may maintain profile information of those caregivers who may be associated with the healthcare facility. Further, one or more memory units of the social media server 114 may be configured to maintain profiles of members of a social media platform hosted by the social media server 114. For instance, the social media platform may correspond to a professional networking platform (e.g., LinkedIn® or a professional networking platform for medical professions), which may include a caregiver as its member. In such a scenario, the profile information of the caregiver may be maintained by the one or more memory units of the social media server 114. In an embodiment, the profile information of a caregiver may include information such as, professional qualifications, work experience, certifications or affiliations, information related to medical knowledge, and patient-caregiving skill set of the caregiver.

In an embodiment, information such as locational availability and calendar activity of a caregiver may either be pre-specified by the caregiver as profile information of the caregiver. For instance, the caregiver may state in the profile information that he/she is available at a particular healthcare facility on “3 weekdays” from “10 am” to “5 pm” and available on call each day from “6 pm” to “8 pm.” Further, the caregiver may state that he/she may be out of town for a conference in particular weeks of the year, and so on. In another embodiment, the locational availability and calendar activity of the caregiver may be tracked through a computing device of the caregiver (e.g., the first caregiver computing device 112a). For instance, the computing device of the caregiver (e.g., the first caregiver computing device 112a) may include a GPS-based location sensor that may track a location of the caregiver (if the caregiver enables location tracking on his/her computing device). Based on a trend of tracked location of the caregiver, information related to the locational availability of the caregiver may be determined. This information may be pulled out periodically by the social media server 114, the DSS server 116, and/or the application server 102 (if the caregiver gives consent to such a tracking).

Further, in another embodiment, the caregiver may update or check into a location or update a calendar activity (such as, a calendar meeting, appointment, or activity) using an application, such as, but not limited to, a social networking platform, a mailing application, or a messaging application. Based on the aforementioned activities, the information pertaining to the locational availability and/or calendar activity of the caregiver may be obtained. In addition, in an embodiment, the caregiver may post one or more social media updates on the social media platform hosted by the social media server 114. The processor 202 may be configured to receive the one or more social media feeds of the caregiver from the social media server 114.

Extraction of the contextual data: In an embodiment, the crawling engine 210, in conjunction with the processor 202, may collect information pertaining to the contextual data of each of the plurality of caregivers from one or more data sources. For instance, the crawling engine 210 may crawl web pages associated with a profile of each caregiver maintained by the social media platform hosted by the social media server 114 and/or the DSS hosted by the DSS server 116. Based on the crawling of the web pages associated with the profile of each caregiver, the information such as professional qualifications, certifications or affiliations, medical knowledge, patient-caregiving skill set, and the like may be extracted. In addition, in some scenarios, the profiles of the caregivers may also include information such as locational availability and calendar activities of the caregivers specified by the caregivers themselves, as explained above. Further, a caregiver may provide locational availability and calendar activity information using an application (social networking platform, a mailing, application, or a messaging application) on the computing device of the caregiver (e.g., the first caregiver computing device 112a). Based on the caregiver's consent, such information may be periodically collected from the aforementioned applications used by the caregiver. Alternatively, the information such as locational availability and calendar activities may be tracked by the computing device of each caregiver (e.g., the first caregiver computing device 112a), as explained above. In such cases, the tracked locational availability and calendar events information may be periodically uploaded to the application server 102, the social media server 114, and/or the DSS server 116. Thus, the processor 202 may receive the tracked locational availability and calendar events information either directly (when uploaded to the application server 102) or from the social media server 114 and/or the DSS server 116. Further, the one or more social media updates posted on the social media platform by the caregiver may be extracted by the crawling engine 210, in conjunction with the processor 202, by crawling web pages related to the caregiver on the social media platform.

At step 304, a customized ontology for the human subject is generated based on the received medical data and the contextual data. In an embodiment, the ontology manager 212, in conjunction with the processor 202, may be configured to generate the customized ontology from a pre-determined ontology associated with a health condition of a plurality of human subjects. Before generating the customized ontology, the ontology manager 212 may retrieve the pre-determined ontology from the database server 104 or the one or more memory units of the application server 102. The retrieval of the pre-determined ontology may be based on the historic medical record data of the human subject, included within the medical data of the human subject. For instance, one or more pre-determined ontologies may be defined for different medical conditions associated with the plurality of human subjects and stored in the database server 104 or the one or more memory units of the application server 102. An example of such pre-determined ontology may be that defined for human subjects with a Diabetes Type-II health condition. The ontology manager 212 may retrieve this pre-determined ontology associated with Diabetes Type-II health condition, if the human subject is identified as suffering from a chronic Diabetes Type-II health condition (based on the historic medical record data), and so on. In an embodiment, the medical condition of the human subject may correspond to a chronic disease or ailment. The plurality of caregivers may provide a medical intervention support to the human subject at the residence of the human subject or at an institutional healthcare facility associated with the plurality of caregivers. In an embodiment, the customized ontology may be a personalized version of a generic pre-determined ontology retrieved based on the health condition of the human subject, to be used by the plurality of caregivers to provide medical invention support to the human subject. An example of a pre-determined ontology for home care is “home_care.owl”®. A schema definition of this ontology may be accessed from: “http://www.cs.stirac.uk/schemas/home_care.owl”®.

In an embodiment, after the retrieval of the appropriate pre-determined ontology for the human subject, the ontology manager 212 may generate the customized ontology for the human subject based on the received medical data and the contextual data. In an embodiment, the customized ontology may correspond to a subject-predicate-object association between the entities modeled using an Entity-Relationship (ER) model. The main entities modeled by the ER model of the customized ontology may be the human subject with the medical condition, the plurality of caregivers associated with the human subject, and/or a plurality of medical intervention activities associated with the human subject. Thus, the customized ontology may model subject-predicate-object associations between the human subject, the plurality of caregivers of the human subject, and the medical intervention activities associated with the human subject. For instance, a customized ontology (or personalized care ontology) of a human subject may at least include health condition-related data, treatment adherence details, and other medical data of the human subject. In addition, the customized ontology of the human subject may include profile information of caregivers associated with the human subject.

In an embodiment, the customized ontology may be built upon a standard medical communication framework, such as the ISBAR framework, utilized for case management and clinical handover reports. The use of the ISBAR framework to organize data of the customized ontology may help streamline medical intervention and healthcare data of human subjects into actionable information for the caregivers and/or the human subjects. The “Identify” in the ISBAR framework may correspond to identity data of the human subject, such as, name, age, gender, address, etc., of the human subject. The “Situate” in the ISBAR framework may correspond to a current situation of the human subject, such as a health condition and severity of the health condition of the human subject. Further, the “Background Check” in the ISBAR framework may correspond to clinical background and context of the human subject, such as known allergens and social issues associated with the human subject. In addition, the “Assessment” in the ISBAR framework may correspond to an identified health condition of the human subject, such as past activity, pain score, or stroke score. Finally, the “Response and Rationale” in the ISBAR framework may correspond to a recommendation of medical intervention or treatment course for the human subject. An exemplary customized ontology based on the ISBAR framework is explained in conjunction with FIG. 4.

In an embodiment, to customize the retrieved pre-determined ontology for the human subject, the ontology manager 212 may reorganize the structure of the pre-determined ontology. The reorganization of the structure of the pre-determined ontology may be performed using the ER model with the human subject, the plurality of caregivers of the human subject, and the medical intervention activities as its entities, which may have subject-predicate-object association. If the structure of the pre-determined ontology is already similar to the intended ER model-based structure of the customized ontology, the structure of the pre-determined ontology may not be required to be reorganized. Further, the ontology manager 212 may populate entries as ER objects into the reorganized structure associated with the customized ontology based on the medical data of the human subject and the contextual data of the plurality of caregivers. In an embodiment, the population of the ER objects into the reorganized structure of the customized ontology may be based on the ISBAR framework. In an embodiment, the ER object values may be stored in the customized ontology using a subject-predicate-object resource description framework (RDF) associated with the customized ontology. Based on the medical data of the human subject, the contextual data of the plurality of caregivers of the human subject, and the customized ontology, one or more trigger rules for a generation of medical intervention notification recommendations may be defined by the ontology manager 212. In an embodiment, a standard Web Ontology Language (OWL) query language may be used to make queries about the entities and their associated relationships within the customized ontology to generate the one or more trigger rules associated with the generation of the recommendations. The ontology manager 212 may store the one or more trigger rules and the customized ontology on the database server 104 and/or the one or more memory units of the application server 102.

A person skilled in the art will understand that the customized ontology may be generated from the pre-determined ontology only once, that is when the medical data (including the periodic physiological data) of the human subject and the contextual data of the plurality of caregivers are initially received. Upon generation of the customized ontology, when the medical data and/or contextual data are received again (after certain period), the customized ontology may be accordingly updated but not be generated again.

Further, a person skilled in the art will understand that the customized ontology may be further modifiable by a caregiver and/or a human subject. For instance, a caregiver may further modify (e.g., add, replace, or delete) one or more nodes of the customized ontology based on a specific treatment requirement associated with the human subject that may not already be incorporated into the customized ontology. In an embodiment, the application server 102 or the DSS server 116 may provide a user interface to view and/or edit the customized ontology. The user interface may include various tools and options for further modification of the customized ontology by a caregiver and/or a human subject according to specific treatment requirements of the human subject and/or constraints of the caregiver. An exemplary interface of an exemplary ontology editor and/or IDE for generation, view, edit, and/or customization of an ontology has been explained further in conjunction with FIG. 4.

At step 306, a recommendation of one or more medical intervention activities for at least one caregiver and/or the human subject is generated based on an analysis of the customized ontology. In an embodiment, the analytics engine 214, in conjunction with the processor 202, may be configured to generate the recommendation of the one or more medical intervention activities based on the analysis of the customized ontology. The generation of the recommendation may be further based on the periodic physiological data of the human subject, caregiver profiles of the plurality of caregivers, and the contextual data of the plurality of caregivers. In an embodiment, the generation of the recommendation may be initiated based on one or more trigger rules associated with the customized ontology, which may be stored on the database server 104 and/or the one or more memory units of the application server 102. In an embodiment, the one or more trigger rules may be based on the execution of a query on the RDF-based customized ontology associated with the human subject, by the analytics engine 214. In an embodiment, the querying of the RDF-based customized ontology may be performed using an RDF query language such as, but not limited to, Simple Protocol and RDF Query Language (SPARQL). An example of a SPARQL-based trigger rule that may be executed by the analytics engine 214 to generate the recommendations is represented below in expression (1).

SELECT ? Identity ? Situate ? Background ? Assessment ? Response ?
Activity
Where
{
Identity: case01
Situate: Diastolic_blood_pressure ?
Background: hasAdherence ?
Assessment: hasHyperglycemia ? Hyperinsulinism ?
Response: hasActivity ? Activity

| | |
|---|---|
| } | ... (1) |

For instance, the above query may be used as a trigger rule to retrieve medical intervention activity recommendation for a human subject with identity as “case01,” health condition situation as “diastolic BP,” and background as “adhering to treatment.” The human subject may be assessed currently with “Hyperglycemia” and/or “Hyperinsulinism.” In the aforementioned example, the execution of the SPARQL query-based trigger rule may result in either a “NULL” ‘Response’ or an ‘Activity’ object ‘Response’. In case of the “NULL” ‘Response’, a recommendation may not be generated and the trigger rule may be executed again after a time period or on updation of the customized ontology (or on receipt a fresh periodic physiological data or contextual data). Alternatively, if an ‘Activity’ object is returned on the execution of the SPARQL query, the ‘Activity’ object may be analyzed with respect to the caregiver profiles associated with the customized ontology. The caregiver profiles associated with the customized ontology may also be stored, along with the customized ontology, on the database server 104 or the one or more memory units of the application server 102. In an embodiment, the retrieved ‘Activity’ object (of ‘Response’ entity) may correspond to a medical intervention activity recommendation associated with the human subject, for a caregiver of the human subject and/or the human subject. In an embodiment, the retrieved medical intervention activity may be sent to different types of caregivers. The examples of different types of caregivers may include, but may not be limited to, a housekeeping chore worker (type A), a resident (type B-situated) or non-resident family member (type B-remote), a resident (type C-situated) or non-resident certified nursing assistant (type C-remote), and/or a doctor, therapist, or registered nurse, associated with the human subject (type D). Thus, there may be, inter alia, six main types of caregivers of a human subject represented by type A (“cg_A”), type B-situated (“cg_B_{S}”), type B-remote (“cg_B_{R}”), type C-situated (“cg_C_{S}”), type C-remote (“cg_C_{R}”), and type D (“cg_D”). In an embodiment, caregivers to whom the medical intervention activity recommendation is to be sent may be selected from the plurality of caregivers by execution of a SPARQL-based trigger rule by the analytics engine 214. An example of such a SPARQL-based trigger rule to select appropriate caregivers based on profiles (or types) of the caregivers is represented below in expression (2).

SELECT ? cgType ? cgFeedback ? cgIntervention ? Recommendation
Where
{
cgIntervention : Activity
cgType : cg_C_{S}
cgFeedback : hasRecieved ? hasResponded ? hasActed ?

| | |
|---|---|
| } | ... (2) |

For instance, according to the above query, a caregiver of the type C-situated (“cg_C_{S}”) who has received, responded, or acted on a previous recommendation of medical intervention activity associated with the human subject, may be selected for transmission of the current recommendation. In an embodiment, the recommendation may be encapsulated in a notification wrapper and sent to the computing device of the respective caregiver (e.g., the first caregiver computing device 112a) and/or the human subject computing device 106 by the reporting engine 216. In an embodiment, the transmission of the recommendation using the notification wrapper has been explained in the forthcoming steps 308 and 310.

At step 308, a message template associated with transmission of notifications may be retrieved. In an embodiment, the reporting engine 216, in conjunction with the processor 202, may be configured to retrieve the message template from the database server 104 and/or the one or more memory units of the application server 102. In an embodiment, the message template may correspond to the notification wrapper that may be used to transmit notifications to the one or more caregiver computing devices 112 and/or the human subject computing device 106. In an embodiment, the message template may be used to transmit pull- or push-based notifications to the caregiver computing devices 112, when the periodic physiological data is received or the recommendation of the medical intervention activities of the human subject is generated. In case of a pull-based notification, a request for the information related to periodic physiological data and/or the latest medical intervention activity recommendation may be received by the reporting engine 216, via the transceiver 208, from a caregiver computing device (e.g., 112a). Thus, a pull-based notification may be generated by the reporting engine 216 in response to such a request received from the computing device of a caregiver (e.g., the first caregiver computing device 112a). Further, a push-based notification may be generated by the reporting engine 216 in response to receipt of the periodic physiological data of the human subject and/or the generation of medical intervention activity recommendation based on the one or more trigger rules.

An example of the message template for a recommendation of a medical intervention activity may be represented in the expression (3) below.

“Hi Caregiver <>, your patient case id: <>, name: <>, requires medical attention!

Please provide medical support to the patient by instructing or helping the patient to:

1. Eat medicine: <>, compound name: <>

2. Eat food: [food-type <>, portion size <>, quantity <>, calories <>]

3. Walk at least <>during the day to burn at least <>calories

4. Sleep for at least <>hours” (3)

Examples of the message templates for notifications sent to the caregivers based on the receipt of the periodic physiological data of the human subject may be represented in the expressions (4), (5), and (6) below.

“Hi Caregiver <>, Patient case id: <>, name: <>, has [taken/not taken] medicines <>, compound name: <>, [around/since] <time>.” (4)

“Hi Caregiver <>, Patient case id: <>, name: <>, has [walked/only walked] [step-count/distance]<value>[till now/since] <time>.” (5)

“Hi Caregiver <>, Patient case id: <>, name: <>, has [taken/not yet taken] food <>, food-type: <>, [around/since] <time>.” (6)

In an embodiment, the retrieval of the message template may be based on the medical condition of the human subject, the periodic physiological data, and/or profile information of the plurality of caregivers. For instance, a specific type of message template may be used for human subjects with a chronic Diabetes Type-II health condition. Such a message template may include a provision for most recent readings of fasting, postprandial, or random blood sugar/glucose level, HbA1C level, heart rate/pulse, and/or blood pressure of the human subject, as per the periodic physiological data of the human subject. The message template may also include a provision for readings of calories consumed and burned through the day by the human subject, as per the periodic physiological data of the human subject. Further, the retrieval of the message template may be based on the profile information of the plurality of caregivers. For instance, in case of a caregiver with adequate medical knowledge of medicine compounds, the message template may be indicative of medicine compounds and strengths (e.g., in “mg”) recommended for the human subject, instead of specific medicine brand names. However, in case of a caregiver with basic medical knowledge such as a family member, the message template may indicate examples of specific medicine brand names that can be given to the human subject, and so on.

A person skilled in the art will understand that the scope of the disclosure should not be limited to the retrieval of the message template by the reporting engine 216, as described above. The message template may be retrieved based on various other parameters. Further, in an embodiment, the human subject computing device 106 may retrieve the message template (in a manner similar to the reporting engine 216) from the database server 104 and/or the one or more memory units of the application server 102 periodically. The human subject computing device 106 may then use the retrieved message template to directly send the periodic physiological data generated during the corresponding time period to the computing device of a caregiver (e.g., the first caregiver computing device 112a) as a notification.

After step 308 of the flowchart 300A (FIG. 3A), flow of the method steps of the flowchart 300A (FIG. 3A) may pass to three parallel sequences of steps. The first of the three parallel sequences of steps may include steps 310, 312, and 314 of the flowchart 300A (FIG. 3A). Further, the second of the three parallel sequences of steps may include steps 316 and 318 of the flowchart 300B (FIG. 3B). In addition, the third of the three parallel sequences of steps may include steps 320 and 322 of the flowchart 300C (FIG. 3C). The three parallel sequences of steps may be performed in any order with respect to one another; however, for the sake of explanation, the three parallel sequences of steps are explained in the order of labeling of the respective steps. The first parallel sequence of steps from steps 310 to 314 is explained next.

At step 310, the generated recommendation is transmitted using the message template, to computing devices of at least one caregiver and/or the human subject. In an embodiment, the reporting engine 216, in conjunction with the processor 202, may be configured to transmit the generated recommendation in the form of a (push- or pull-based) notification using the message template retrieved in step 308. The generated notification may be transmitted via the transceiver 208, over the communication network 118. The notification may include the latest periodic physiological data of the human subject and/or recommendation of one or more medical intervention activities associated with the human subject. The at least one caregiver to whom the notification is to be transmitted may be selected during the generation of the recommendation based on one or more trigger rules (for instance, the trigger rule of the SPARQL query represented in the expression (2)). Non-limiting examples of the message template that may be used for the transmission of the notification have been illustrated in the expressions (3), (4), (5), and (6) above. In an embodiment, the reporting engine 216 may transmit the notifications to the computing device of the at least one caregiver (e.g., the first caregiver computing device 112a) and/or the human subject computing device 106.

At step 312, information pertaining to feedback to the recommendations may be received from a computing device of the at least one caregiver (e.g., the first caregiver computing device 112a) and/or the human subject (i.e., the human subject computing device 106). In an embodiment, the ontology manager 212, in conjunction with the processor 202, may be configured to receive the information pertaining to the feedback, via the transceiver 208 over the communication network 118. In an embodiment, the information pertaining to the feedback may include details related to the actions taken by the at least one caregiver and/or the human subject based on the notifications including the medical intervention activity recommendations transmitted by the reporting engine 216. Examples of the feedback may include indications such as, but not limited to, the notification being read by a recipient of the notification, the notification being responded to by the recipient, and/or the notification being acted upon by the recipient. In an embodiment, the ontology manager 212 may be configured to update the customized ontology based on the received information pertaining to the feedback to the transmitted notifications of the medical intervention activity recommendations, as described next.

At step 314, the customized ontology may be updated based on the received information pertaining to the feedback. In an embodiment, the ontology manager 212, in conjunction with the processor 202, may be configured to update the customized ontology based on the received information pertaining to the feedback. For instance, a “Caregiver” object in the ER model of the customized ontology may include properties such as “caregiver type,” “caregiver intervention,” and “caregiver feedback.” Based on the feedback information received from a caregiver, the “Caregiver” object of that caregiver may be updated in the customized ontology with respect to the properties “caregiver intervention” and “caregiver feedback.” The property “caregiver intervention” may correspond to information related to medical intervention activities performed by the caregiver for the human subject. Further, the property “caregiver feedback” may correspond to information related to feedback to the recommendation notification provided by the caregiver. The second of the three parallel sequences of steps including steps 316 and 318 of the flowchart 300B have been described next in conjunction with FIG. 3B.

FIG. 3B is a flowchart that illustrates a method for transmission of handover reports to caregivers, in accordance with at least one embodiment. With reference to FIG. 3B, there is shown a flowchart 300B. The flowchart 300B of FIG. 3B has been described in conjunction with FIG. 1, FIG. 2, and FIG. 3A. The flowchart 300B illustrates the method that starts at step 316.

At step 316, a handover report may be generated for a second caregiver. In an embodiment, the reporting engine 216, in conjunction with the processor 202, may be configured to generate the handover report based on the type of the second caregiver and/or the periodic physiological data of the human subject. In an embodiment, the second caregiver may correspond to a caregiver who may take over medical intervention support responsibilities associated with the human subject from a first human subject. In an embodiment, the generation of the handover report may also be based on the type of the first caregiver and/or profile information of both the first caregiver and the second caregiver. For instance, the handover report may include the latest periodic physiological data of the human subject, the latest medical intervention activity recommendation associated with the human subject, and/or the feedback information received in response to the recommendation. Further, the handover report may include details of the monitored health condition of the human subject and specific instructions regarding the treatment course of the human subject. In addition, the handover report may include medical notes or patient care guidelines for the human subject provided by the first caregiver, who was taking care of the human subject before the second caregiver.

At step 318, the generated handover report may be transmitted to computing devices of the second caregiver (e.g., the second caregiver computing device 112b) and/or the human subject (i.e., the human subject computing device 106). In an embodiment, the reporting engine 216, in conjunction with the processor 202, may be configured to transmit the generated handover report to the computing devices of the second caregiver (e.g., 112b) and/or the human subject (i.e., the human subject computing device 106). The handover report may be transmitted via the transceiver 208, over the communication network 118. In an embodiment, the transmission of the handover report may also be based on a message template, in a manner similar to the transmission of the notifications of medical intervention activity recommendations. The retrieval of an appropriate message template for the transmission of the handover report may be performed in a manner similar to that described in step 308 of flowchart 300A (FIG. 3A). In addition to transmission of the handover report to the computing devices of the second caregiver (e.g., the second caregiver computing device 112b) and/or the human subject (i.e., the human subject computing device 106), the reporting engine 216 may also transmit the handover report to a computing device of the first caregiver (e.g., the first caregiver computing device 112a). Further, in an embodiment, the reporting engine 216 may also transmit the handover report to the DSS server 116 for record purposes. In another embodiment, the handover report may be sent to the database server 104 and/or the one or more memory units of the application server 102 for storage. The third of the three parallel sequences of steps including steps 320 and 322 of the flowchart 300C have been described next in conjunction with FIG. 3C.

FIG. 3C is a flowchart that illustrates a method for transmission of handover reports to caregivers, in accordance with at least one embodiment. With reference to FIG. 3C, there is shown a flowchart 300C. The flowchart 300C of FIG. 3C has been described in conjunction with FIG. 1, FIG. 2, and FIG. 3A. The flowchart 300C illustrates the method that starts at step 320.

At step 320, a dashboard report of the human subject may be generated based on the medical intervention activity recommendations and/or the periodic physiological data of the human subject. In an embodiment, the reporting engine 216, in conjunction with the processor 202, may be configured to generate the dashboard report of the human subject based on the generated recommendations of medical intervention activities and/or the periodic physiological data of the human subject. In an embodiment, the analytics engine 214 and/or the reporting engine 216 may analyze the periodic physiological data of the human subject to generate medical adherence or compliance information associated with the human subject. Based on the analysis of the periodic physiological data of the human subject, the analytics engine 214 and/or the reporting engine 216 may also determine the human subject's current health condition, context, and other related data. The reporting engine 216 may collate the generated medical adherence/compliance information, current health condition, context, and other data related to the human subject as information pertaining to the dashboard report of the human subject. In addition, the analytics engine 214 and/or the reporting engine 216 may retrieve information pertaining to historic dashboard reports of the human subject from the database server 104, the DSS server 116, and/or the one or more memory units of the application server 102. The analytics engine 214 and/or the reporting engine 216 may correlate and analyze trends across the information pertaining to the current dashboard report and the information pertaining to the historic dashboard reports. Based on the correlation and analysis of the trends, the analytics engine 214 and/or the reporting engine 216 may generate a health condition progress report of the human subject. The reporting engine 216 may also include information pertaining to the health condition progress report of the human subject to the information pertaining to the current dashboard report of the human subject.

At step 322, the dashboard report of the human subject may be presented to the plurality of caregivers and/or the human subject. In an embodiment, the reporting engine 216, in conjunction with the processor 202, may be configured to transmit the information pertaining to the current dashboard report to the DSS server 116, via the transceiver 208, over the communication network 118. In addition, the reporting engine 216 may also send the information pertaining to the current dashboard to the database server 104 and/or one or more memory units of the application server 102 for storage or later use. In an embodiment, the plurality of caregivers and/or the human subject may use their respective computing devices (i.e., the one or more caregiver computing devices 112 and/or the human subject computing device 106) to access the dashboard report through a user interface of the DSS. The dashboard report of the human subject may be provided by the DSS to users of the DSS (such as, the plurality of caregivers and/or the human subject) through a user interface of the DSS. An example of a user interface of the DSS for presentation of the information pertaining to the dashboard report of the human subject to the users of the DSS has been explained in conjunction with FIG. 5. Further, an example of a user interface of the DSS for presentation of profile information of caregivers and administration of caregiver roles for a human subject has been explained in conjunction with FIG. 6.

FIG. 4 is a diagram that illustrates exemplary interface of an exemplary ontology editor and/or IDE for generation, view, edit, and/or customization of an ontology, in accordance with at least one embodiment. FIG. 4 is explained in conjunction with elements from FIG. 1, FIG. 2, FIG. 3A, FIG. 3B, and FIG. 3C. With reference to FIG. 4, there is shown a user interface 400 including an ontology listing 402, view/edit tool area 404, and a customized ontology 406. The view/edit tool area 404 is shown to include view tools such as a textbox 408, a dropdown 410, a search button 412, and a clear button 414. The view/edit tool area 404 is shown to further include edit tools, such as tools T₁ 416a, T₂ 416b, T₃ 416c, . . . T₁ 416i, . . . Tₙ 416n. The user interface 400 is further shown to include a pointer arrow 418.

As shown in FIG. 4, the ontology listing 402 on the left end of the user interface 400 may provide a hierarchical summary list of customized ontology 406. As explained earlier in conjunction with FIG. 3A, the customized ontology 406 may include a subject-predicate-object association between human subjects with medical condition, caregivers of the human subjects, and medical intervention activities associated with the human subject. In an embodiment, the customized ontology may be utilized to generate one or more handover reports personalized for the at least one caregiver. In an embodiment, the customized ontology 406 may be realized as an ER model with human subjects, caregivers, and medical intervention activities as entities that may have the subject-predicate-object association among them. Further, as explained earlier in FIG. 3A, the customized ontology 406 may be based on the ISBAR framework for recording of data associated with the human subjects as this framework may result in recording of actionable information for medical interventions. For instance, as shown in FIG. 4, the ontology listing 402 and the customized ontology 406 depict the three main entities “Caregiver,” “Patient,” and “Role” (that correspond to medical intervention activities). The properties of the “Patient” entity are shown to include “ptnAssessment,” “ptnBackground,” “ptnIdentity,” “ptnResponse,” and “ptnSituate” that may be modeled on the basis of the ISBAR framework.

In an embodiment, the user interface 400 may be presented by the application server 102 or the DSS server 116 to caregivers and/or human subject to view/edit the customized ontology 406. The customized ontology 406 may be viewed and/or edited according to specific treatment requirements of the human subjects and/or constraints of the caregivers by the caregivers and/or the human subjects using the user interface 400. For instance, the view/edit tool area 404 may include various tools to search for an entry from the customized ontology 406. A user (e.g., a caregiver and/or a human subject) may enter a search term in the textbox 408 and choose a filter criteria, such as contains (or does not contain) a keyword from the dropdown 410 and press the search button 412 to search for medical intervention information related to a particular human subject. The user may further press the clear button 414 to clear the textbox 408 and the selected filter criteria of the dropdown 410 before performing another search. Further, the view/edit tool area 404 may include various edit tools such as the tools T₁ 416a, T₂ 416b, T₃ 416c, . . . T₁ 416i, . . . Tₙ 416n. The user may use the aforementioned tools to either alter a structure of the customized ontology 406, selected information from the customized ontology 406, and/or delete/alter a part of the customized ontology 406 (such as an entity or a relationship). In addition, the user may control the pointer arrow 418 through a mouse or a touch screen interface to edit the customized ontology 406 by clicking, dragging, dropping, and/or hovering over the customized ontology 406 and/or in conjunction with use of appropriate tools from the view/edit tool area 404. It may be noted that the exemplary user interface 400 of FIG. 4 should not be construed to limit the scope of the disclosure, as the user interface 400 is merely for exemplary purposes.

FIG. 5 is a diagram that illustrates a user interface of a dashboard report of a human subject, in accordance with at least one embodiment. FIG. 5 is explained in conjunction with elements from FIG. 1, FIG. 2, FIG. 3A, FIG. 3B, and FIG. 3C. With reference to FIG. 5, there is shown a user interface 500 of a dashboard report of the human subject. The user interface 500 is shown to include a search textbox 502, navigation tabs 504, a title information area 506, and a dashboard information area 508. Further, the dashboard information area 508 is shown to include a user's state region 510, a user's context region 512, a channel region 514, and user data (e.g., EHR and sensor data) region 516. In addition, the dashboard information area 508 is further shown to include an adherence history graph 518, a rewards graph 520, and a compliance graph 522.

In an embodiment, the user interface 500 of the dashboard report may be presented by the DSS (hosted by the DSS server 116) and/or the application server 102 to users of the DSS on their respective computing devices. In an embodiment, the user of the user interface 500 may correspond to the plurality of caregivers associated with the human subject, the human subject, and/or an administrator of a healthcare facility associated with treatment of the human subject. Thus, the user interface 500 may be presented on the one or more caregiver computing devices 112, the human subject computing device 106, and/or a computing device of an administrator of a healthcare facility treating the human subject. Based on the dashboard report of the human subject, the plurality of caregivers, the human subject, and/or the healthcare facility administrator may make decisions related to medical invention activities, treatment course, and provision of medical diagnosis or consultation for the human subject.

As shown in the user interface 500, the search textbox 502 may be used to search for information related to a caregiver, a human subject, medical adherence or compliance details, medical intervention activities, and other medical data related to the human subject. Further, the navigation tabs 504 may be used to navigate within different sections of the dashboard report of the human subject. For instance, the first tab in the navigation tabs 504 has been shown as highlighted or selected by a user. This first tab may correspond to a main dashboard tab that may be selected to view information related to the main dashboard report of the human subject. In addition, examples of the other tabs in the navigation tabs 504 may include, but may not be limited to, a flags tab, an adherence calendar tab, and an intervention list tab. In an embodiment, the flags tab may present a summary of instances of non-compliance to a medical treatment, intervention activity, or diet plan regime associated with the human subject. The adherence calendar tab, on the other hand, may present adherence details related to a current and historic medical treatment, intervention activity, or diet plan regime associated with the human subject overlaid on a calendar for easy comparison. In an embodiment, the intervention list tab may present a summary of currently recommended (and/or historic) medical intervention activities for performance by (or already performed by) the caregivers of the human subject and/or the human subject.

In addition, as shown in the user interface 500, the title information area 506 may provide generic information related to a context of access or a current session related to the user interface 500. For instance, as shown in FIG. 5, the title information area 506 may display a user name (e.g., a user “Abc”), user id (e.g., a user id “#1234”), and location of the user (e.g., location “Xyz” of the user “Abc”) currently logged in and accessing the user interface 500. Further, the title information area 506 may display an indication of the currently displayed tab (e.g., “Home→Dashboard” tab) of the user interface 500. In addition, the title information area 506 may also display a current date, day, and current time (for instance in the format “MM/DD/Y|hh:mm:ss”).

In an embodiment, the dashboard information area 508 may display the information pertaining to the dashboard report of the human subject, as explained next. The dashboard information area 508 may display the user's state region 510, the user's context region 512, the channel region 514, and the user data (e.g., EHR and sensor data) region 516. In an embodiment, the user's state region 510 may indicate an extent of compliance of the human subject to medical treatment course, intervention activities, or diet plan regime associated with the human subject. The user's context region 512, on the other hand, may present information related to a current context of the human subject. Further, the channel region 514 may present information related to caregivers, physicians, medical practitioners, and experts associated with provision medical intervention support to the human subject. In addition, the user data region 516 may present information associated with the periodic physiological data of the human subject. For instance, the user's state region 510 may indicate that the human subject may be 65% compliant with the medical treatment and intervention activities related to the human subject. Further, the user's context region 512 may indicate that the human subject may be currently traveling (for instance on a vacation on a cruise or a flight). In addition, the channel region 514 may indicate the specific caregivers (e.g., family members) and medical professionals (e.g., doctors or nurses) who may be taking care of the human subject by providing medical intervention support to the human subject. Further, the user data region 516 may indicate the latest readings of the human subject's random blood sugar level, blood pressure level, heart rate/pulse, and/or activity, food, and medicine intake data, and so on.

A person skilled in the art may understand that each of the user's state region 510, the user's context region 512, the channel region 514, and the user data region 516 may be selectable by the user of the user interface 500 to view further details related to the respective region. The selection of the aforementioned regions may be performed by the use of a mouse or a touch screen-based interface of a computing device of the user of the user interface 500.

In an embodiment, the dashboard information area 508 may further display the adherence history graph 518, the rewards graph 520, and the compliance graph 522. The adherence history graph 518 may present a trend of the adherence of the caregivers and/or the human subject to prescribed or recommended medical intervention activities associated with the human subject over a period of time. The adherence history graph 518 may also present a trend of feedback received from the caregivers and/or the human subject to the prescribed or recommended medical invention activities associated with the human subject. In an embodiment, the rewards graph 520 may present a trend of rewards provided to the caregivers and/or the human subject over a period of time. The rewards may be provided for compliance or adherence to the prescribed or recommended medical intervention activities or diet regime associated with the human subject. Examples of the rewards may include, but may not be limited to, monetary rewards or non-monetary rewards, such as points, redeemable gift certificates, or discount coupons, and the like. In addition, in an embodiment, the compliance graph 522 may present a trend of compliance of medicine and food intake, activity trend, or diet regime associated with the human subject by the human subject.

A person skilled in the art will understand that the scope of the disclosure should not be limited to only the user's state region 510, the user's context region 512, the channel region 514, and the user data region 516 in the dashboard information area 508. Various other regions indicative of other details related to the medical intervention activities and compliance or adherence of the caregivers and/or the human subject to the medical intervention activity recommendations may be provided within the dashboard information area 508. Further, a person skilled in the art will understand that the dashboard information area 508 may include various other types of graphs, in addition to the adherence history graph 518, the rewards graph 520, and the compliance graph 522.

FIG. 6 is a diagram that illustrates a user interface for presentation of profile information of caregivers and administration of caregiver roles for a human subject, in accordance with at least one embodiment. FIG. 6 is explained in conjunction with elements from FIG. 1, FIG. 2, FIG. 3A, FIG. 3B, and FIG. 3C. With reference to FIG. 6, there is shown a user interface 600 that may include a search textbox 602, a caregiver selection area 604, and a title information area 606. Further, the user interface 600 may include multiple selectable tabs related to type of caregivers such as a hospital situated tab 608, a hospital outstation tab 610, a home care staff tab 612, and a family/others tab 614. In addition, the user interface 600 is further shown to include a caregiver profile 616 of a caregiver currently selected from the caregiver selection area 604. The user interface 600 is also shown to include an edit button 618 and a delete button 620 to perform editing or deletion operations on the caregiver profile 616 of the currently selected caregiver.

In an embodiment, the user interface 600 may be presented by the DSS (hosted by the DSS server 116) and/or the application server 102 to users of the DSS on their respective computing devices. In an embodiment, the user of the user interface 600 may correspond to the plurality of caregivers associated with the human subject, the human subject, and/or an administrator of a healthcare facility associated with treatment of the human subject. Thus, the user interface 600 may be presented on the one or more caregiver computing devices 112, the human subject computing device 106, and/or a computing device of an administrator of a healthcare facility treating the human subject. The users of the user interface 600 may add, edit, or delete caregiver profiles of caregivers associated with a human subject. Thus, the user interface 600 may be used to view profile information of caregivers who have been currently assigned to provide medical intervention support to the human subject. The profile information of a caregiver assigned to the human subject may be edited or the caregiver may be removed (or unassigned) and/or substituted by another caregiver, based on convenience, compliance, or other constraints of the caregivers and/or the human subjects, by use of the user-interface 600.

As shown in the user interface 600, the search textbox 602 may be used to search for information related to a caregiver, a human subject, medical adherence or compliance details, medical intervention activities, and other medical data related to the human subject. In an embodiment, the functionality of the search textbox 602 may be similar to the search textbox 502 of the user interface 500 (FIG. 5). Further, the caregiver selection area 604 may display a selectable list of caregivers currently assigned to provide medical intervention support to the human subject. The caregiver selection area 604 may also include an option to add a new caregiver who may be assigned to provide medical intervention support to the human subject. For instance, as shown in FIG. 6, the caregiver selection area 604 displays a list of three caregivers: a caregiver “CG_1,” a caregiver “CG_2,” and a caregiver “CG_3,” of which the first caregiver (i.e., “CG_1”) is shown to be selected. The list of the caregivers also indicates basic details about the caregivers. For instance, the first caregiver “CG_1” is indicated as a “primary caregiver” who is a “female” aged “30.” Further, the second caregiver “CG_2” is a “male” aged “28,” and the third caregiver “CG_3” is a “standby caregiver” who is a “female” aged “34.” In addition, as shown in FIG. 6, the first line of the caregiver selection area 604 includes an “add more” link that may be used to add an additional caregiver for provision of medical intervention support to the human subject.

Further, as shown in the user interface 600, the title information area 606 may provide generic information related to a context of access or a current session related to the user interface 600. For instance, as shown in FIG. 6, the title information area 606 may display a user name (e.g., a user “Pqr”), user id (e.g., a user id “#5678”), and location of the user (e.g., location “Xyz” of the user “Pqr”) currently logged in and accessing the user interface 600. Further, the title information area 606 may display an indication of the currently displayed tab (e.g., “Home→Caregiver Profiles” tab) of the user interface 600. In addition, the title information area 606 may also display a current date, day, and time in real time (for instance, in the format “MM/DD/YY|hh:mm:ss”). In an embodiment, the title information area 606 may be similar to the title information area 506 of the user interface 500 (FIG. 5).

In an embodiment, the user interface 600 may further display the multiple selectable tabs related to type of caregivers such as the hospital situated tab 608, the hospital outstation tab 610, the home care staff tab 612, and the family/others tab 614. The currently selected tab from the aforementioned multiple selectable tabs (i.e., 608 to 614) may correspond to the type of caregiver currently selected from the caregiver selection area 604. For instance, as shown in FIG. 6, the home care staff tab 612 may be selected if the type of the caregiver “CG_1” selected from the caregiver selection area 604 corresponds to a home-situated caregiver. A person skilled in the art may understand that the aforementioned multiple selectable tabs (i.e., 608 to 614) may also be selected before addition of a new caregiver to add the new caregiver to the corresponding type of caregivers associated with the selected tab.

In an embodiment, the user interface 600 may further display the caregiver profile 616 of the caregiver currently selected from the caregiver selection area 604. The caregiver profile 616 may be edited or deleted by use of buttons such as the edit button 618 and the delete button 620. Examples of the profile information of a caregiver that may be displayed as the caregiver profile 616 may include, but may not be limited to, type of caregiver, compliance information, medical qualification, certification, affiliation, and association with a healthcare facility, locational availability details, and contact details. For instance, as shown the caregiver profile 616 in FIG. 6, the “CG_1,” a primary caregiver of the human subject, is a “Nursing Assistant” at “Park View Hospital, XYZ” and has “86 percent” compliance in delivery of medical intervention support to the human subject. Further, the caregiver profile 616 states that the caregiver “CG_1” is available from “7:00 hours” to “17:00 hours” and on call from “18:00 hours” to “21:00 hours.” In addition, the caregiver profile 616 includes primary contact number of the caregiver “CG_1” as “(NNN)-(nnn)-(mmmm)” and secondary contact number of the caregiver “CG_1” as “(NNN)-(nnn)-(pppp).” A person skilled in the art will understand that the information template presented in the caregiver profile 616 is for exemplary purposes and should not be construed to limit the scope of the disclosure.

The disclosed embodiments encompass numerous advantages. The disclosure provides a method and system to recommend medical intervention activities for caregivers and/or human subjects. The disclosure provides for periodic generation and receipt of physiological data of a human subject (i.e., the periodic physiological data) and contextual data of a plurality of caregivers of the human subject in real time. In addition, historic medical record data of the human subject may also be received along with the periodic physiological data (collectively referred to as the medical data of the human subject). Based on the medical data and the contextual data, a customized ontology for the human subject may be generated from a pre-determined ontology. The pre-determined ontology may be associated with the medical condition of a plurality of human subjects. For instance, a pre-determined ontology related to a medical condition of “Type-II Diabetes” may be personalized for the human subject as the customized ontology based on the medical data of the human subject and the contextual data of the plurality of caregivers. Thereafter, recommendations of medical intervention activities for at least one of the plurality of caregivers and/or the human subject may be generated based on the analysis of the customized ontology, caregiver profiles, the received contextual data, and the periodic physiological data.

The use of an ontological approach to handle a specific patient health condition, patient medical data, caregiver profile and compliance data, and medical intervention data may be useful to generate meaningful recommendations of medical intervention activities to appropriate caregivers and/or the human subject himself/herself. Further, as mentioned above, the customized ontology may be realized using the ISBAR framework for recording of medical data of human subjects. The use of the ISBAR framework in the customized ontology may further help to streamline organization of medical data of the human subjects within the customized ontology to generate actionable recommendations. The disclosure provides for various types of reporting based on the medical intervention activity recommendations associated with the human subject, the periodic physiological data of the human subject, the caregiver profiles, and/or the contextual data of the caregivers. For instance, pull- or push-based notifications including the recommendations may be transmitted to the computing devices of the caregivers and/or the human subject in real time. Further, handover reports based on type or profile of the new caregiver and the latest periodic physiological data of the human subject may be useful in various settings, including a healthcare facility where the human subject may be treated as an in-patient. In addition, the dashboard reports of human subjects for view through the user interface of the DSS (e.g., a DSS of a healthcare facility) may be useful to make decisions related to the treatment course of the human subject.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be an HDD or a removable storage drive such as a floppy disk drive and an optical disk drive. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’, and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for data processing to recommend medical intervention activities for caregivers and/or human subjects have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules that are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for data processing to recommend medical intervention activities for caregivers and/or human subjects, the method comprising:
receiving, by one or more transceivers in a computing device, over a communication network:
medical data including at least periodic physiological data of a human subject received from the one or more sensors in real-time, and
contextual data of each of a plurality of caregivers associated with the human subject received from one or more data sources;
generating, by one or more processors in the computing device, a customized ontology, from a pre-determined ontology associated with medical condition of a plurality of human subjects, based on the received medical data of the human subject and the contextual data of each of the plurality of caregivers;
generating, by the one or more processors, a recommendation of one or more medical intervention activities for at least one caregiver from the plurality of caregivers and/or the human subject, based on analysis of the generated customized ontology, a plurality of caregiver profiles, the received contextual data of the plurality of caregivers, and the periodic physiological data of the human subject; and
transmitting, by the one or more transceivers, the generated recommendation to a first user-computing device associated with the at least one caregiver and/or a second user-computing device associated with the human subject over the communication network.

2. The method of claim 1, wherein the medical data further includes historic medical record data associated with the human subject received from one or more memory devices.

3. The method of claim 1, wherein the periodic physiological data of the human subject includes one or more of: a measure of one or more physiological parameters, activity data, food and medicine intake data, and/or sleep and rest data, associated with the human subject.

4. The method of claim 1, wherein the contextual data of each of the plurality of caregivers includes one or more of: a medical knowledge and patient-caregiving skill set, locational availability, calendar activity, and/or one or more social media feeds, associated with the caregiver.

5. The method of claim 1, wherein the customized ontology corresponds to a subject-predicate-object association between the human subject with the medical condition, the plurality of caregivers associated with the human subject, and/or a plurality of medical intervention activities associated with the human subject.

6. The method of claim 1, wherein the customized ontology corresponds to a standard medical communication framework utilized for case management and clinical handover reports.

7. The method of claim 1, wherein the plurality of caregivers include one or more of: a housekeeping chore worker associated with the human subject, a resident or non-resident family member associated with the human subject, a resident or non-resident certified nursing assistant associated with the human subject, and/or a doctor, therapist, or registered nurse associated with the human subject.

8. The method of claim 1, wherein the medical condition of the human subject corresponds to a chronic disease or ailment, wherein the plurality of caregivers provide a medical intervention support to the human subject at a residence of the human subject or at an institutional healthcare facility associated with the plurality of caregivers.

9. The method of claim 1, wherein the transmission of the generated recommendation is based on a message template associated with the health condition associated with the human subject, the periodic physiological data associated with the human subject, and/or the plurality of caregiver profiles.

10. The method of claim 1 further comprising receiving, by the one or more transceivers, a feedback associated with an action taken by the human subject and/or the caregiver based on the transmitted recommendation, from the first user-computing device associated with the caregiver and/or the second user-computing device associated with the human subject over the communication network.

11. The method of claim 10 further comprising updating, by the one or more processors, the customized ontology based on the received feedback.

12. The method of claim 1 further comprising generating, by the one or more processors, a handover report for a second caregiver from the plurality of caregivers based on a type or profile of the second caregiver and/or the periodic physiological data of the human subject, wherein the second caregiver takes over a medical intervention support responsibility related to the human subject from a first caregiver from the plurality of caregivers.

13. The method of claim 12 further comprising transmitting, by the one or more transceivers, the handover report for the second caregiver to a third user-computing device associated with the second caregiver and/or the first user-computing device associated with the human subject over the communication network.

14. The method of claim 1 further comprising generating, by the one or more processors, a dashboard report associated with the human subject based on one or more of: the generated recommendation of the one or more medical intervention activities and/or the periodic physiological data associated with the human subject, wherein the dashboard report is presented to a caregiver from the plurality of caregivers and/or the human subject through a user-interface of a decision support system.

15. A system for data processing to recommend medical intervention activities for caregivers and/or human subjects, the data processing system comprising:
one or more transceivers configured to receive over a communication network:
medical data including at least periodic physiological data of a human subject received from the one or more sensors in real-time, and
contextual data of each of a plurality of caregivers associated with the human subject received from one or more data sources; and
one or more processors configured to:
generate a customized ontology, from a pre-determined ontology associated with medical condition of a plurality of human subjects, based on the received medical data of the human subject and the contextual data of each of the plurality of caregivers; and
generate a recommendation of one or more medical intervention activities for at least one caregiver from the plurality of caregivers and/or the human subject, based on analysis of the generated customized ontology, a plurality of caregiver profiles, the received contextual data of the plurality of caregivers, and the periodic physiological data of the human subject,
wherein the one or more transceivers are further configured to transmit the generated recommendation to a first user-computing device associated with the at least one caregiver and/or a second user-computing device associated with the human subject over the communication network.

16. The system of claim 15, wherein the medical data further includes historic medical record data associated with the human subject received from one or more memory devices, wherein the periodic physiological data of the human subject includes one or more of: a measure of one or more physiological parameters, activity data, food and medicine intake data, and/or sleep and rest data, associated with the human subject.

17. The system of claim 15, wherein the contextual data of each of the plurality of caregivers includes one or more of: a medical knowledge and patient-caregiving skill set, locational availability, calendar activity, and/or one or more social media feeds, associated with the caregiver.

18. The system of claim 15, wherein the customized ontology corresponds to a subject-predicate-object association between the human subject with the medical condition, the plurality of caregivers associated with the human subject, and/or a plurality of medical intervention activities associated with the human subject, wherein the customized ontology is utilized to generate one or more handover reports personalized for the at least one caregiver.

19. The system of claim 15, wherein the plurality of caregivers include one or more of: a housekeeping chore worker associated with the human subject, a resident or non-resident family member associated with the human subject, a resident or non-resident certified nursing assistant associated with the human subject, and/or a doctor, therapist, or registered nurse associated with the human subject.

20. The system of claim 15, wherein the medical condition of the human subject corresponds to a chronic disease or ailment, wherein the plurality of caregivers provide a medical intervention support to the human subject at a residence of the human subject or at an institutional healthcare facility associated with the plurality of caregivers.

21. The system of claim 15, wherein the transmission of the generated recommendation is based on a message template associated with the health condition associated with the human subject, the periodic physiological data associated with the human subject, and/or the plurality of caregiver profiles.

22. The system of claim 15, wherein the one or more transceivers are further configured to receive a feedback associated with an action taken by the human subject and/or the caregiver based on the transmitted recommendation, from the first user-computing device associated with the caregiver and/or the second user-computing device associated with the human subject over the communication network.

23. The system of claim 22, wherein the one or more processors are further configured to update the customized ontology based on the received feedback.

24. The system of claim 15, wherein the one or more processors are further configured to generate a handover report for a second caregiver from the plurality of caregivers based on a type or profile of the second caregiver and/or the periodic physiological data of the human subject, wherein the second caregiver takes over a medical intervention support responsibility related to the human subject from a first caregiver from the plurality of caregivers.

25. The system of claim 24, wherein the one or more transceivers are further configured to transmit the handover report for the second caregiver to a third user-computing device associated with the second caregiver and/or the first user-computing device associated with the human subject over the communication network.

26. The system of claim 15, wherein the one or more processors are further configured to generate a dashboard report associated with the human subject based on one or more of: the generated recommendation of the one or more medical intervention activities and/or the periodic physiological data associated with the human subject, wherein the dashboard report is presented to a caregiver from the plurality of caregivers and/or the human subject through a user-interface of a decision support system.

27. A computer program product for use with a computing device, the computer program product comprising a non-transitory computer readable medium, wherein the non-transitory computer readable medium stores a computer program code for data processing to recommend medical intervention activities for caregivers and/or human subjects, wherein the computer program code is executable by one or more processors in the computing device to:
receive, by one or more transceivers in the computing device, over a communication network:
medical data including at least periodic physiological data of a human subject received from the one or more sensors in real-time, and
contextual data of each of a plurality of caregivers associated with the human subject received from one or more data sources;
generate, by the one or more processors, a customized ontology, from a pre-determined ontology associated with medical condition of a plurality of human subjects, based on the received medical data of the human subject and the contextual data of each of the plurality of caregivers;
generate, by the one or more processors, a recommendation of one or more medical intervention activities for at least one caregiver from the plurality of caregivers and/or the human subject, based on analysis of the generated customized ontology, a plurality of caregiver profiles, the received contextual data of the plurality of caregivers, and the periodic physiological data of the human subject; and
transmitting, by the one or more transceivers, the generated recommendation to a first user-computing device associated with the at least one caregiver and/or a second user-computing device associated with the human subject over the communication network.
